(19) United States
(12) Patent Application Publication
(10) Pub. No.: US 2023/0401888 A1
(43) Pub. Date: Dec. 14, 2023

(54) CONTACTLESS BIOMETRIC AUTHENTICATION DEVICE, CONTACTLESS BIOMETRIC AUTHENTICATION SYSTEM AND CONTACTLESS BIOMETRIC AUTHENTICATION METHOD

(71) Applicant: Hitachi Industry & Control Solutions, Ltd., Hitachi-shi (JP)

(72) Inventors: Yo NONOMURA, Tokyo (JP); Akio NAGASAKA, Tokyo (JP); Naoto MIURA, Tokyo (JP); Yusuke MATSUDA, Tokyo (JP); Keiichiro NAKAZAKI, Tokyo (JP); Masahiro KATO, Tokyo (JP); Shinichi SAITO, Hitachi-shi (JP); Kyoichi TAKAHASHI, Hitachi-shi (JP)

(21) Appl. No.: 18/207,174

(22) Filed: Jun. 8, 2023

(30) Foreign Application Priority Data
Jun. 14, 2022 (JP) 2022-095630

(51) Int. Cl. G06V 40/13; G06V 10/141

(52) U.S. Cl. CPC G06V 40/1312; G06V 10/141

(57) ABSTRACT

A contactless biometric authentication device including an insertion chamber with an opening in one side and a space into which an authenticator's finger is inserted; a shooting device positioned to capture the ventral side of the finger inserted into the insertion chamber; a first light source installed in the insertion chamber at a position on the far side of the shooting device and emits light toward the shooting device, the light being blocked by the inserted finger; a second light source provided at a position higher than a height at which the finger is inserted and emits light within a predetermined range including the shooting device when the light from the first light source is blocked by the finger, the light being absorbed by a blood vessel of the finger; and a reflection surface provided in the insertion chamber and receives and reflects the light from the second light source.

### CROSS-REFERENCE TO RELATED APPLICATION

This patent application is based on and claims priority pursuant to 35 U.S.C. § 119(a) to Japanese Patent Application No. 2022-095630, filed on Jun. 14, 2022 in the Japan Patent Office, the entire disclosure of which is hereby incorporated by reference herein.

### BACKGROUND

### Technical Field

The present disclosure relates to a contactless biometric authentication device, a contactless biometric authentication system, and a contactless biometric authentication method.

### RELATED ART

One type of biometric authentication device that uses biological information to identify individuals is a device that utilizes blood vessels in the human body. This device utilizes the fact that the pattern of blood vessels is unique to each person. For example, by irradiating the finger with near-infrared ray light from a predetermined light source, the pattern of blood vessels can be made visible. The device then performs personal authentication by comparing this blood vessel pattern with the pre-registered pattern of the individual. For instance, Japanese Patent No. 4207717 (describes an example of a personal authentication device that captures the pattern of finger blood vessels by emitting near-infrared rays from above the finger held against the device and performs personal authentication.

### SUMMARY

The device described in Japanese Patent No. 4207717 performs personal authentication by directly touching the device with a finger. However, in recent years, there has been a growing need to perform personal authentication without touching the device, from the perspective of hygiene and infection prevention.

However, when performing authentication without touching the device with a finger, it becomes difficult to keep still the position of the finger. As a result of the position of the finger being different for each authentication, there is a risk that the accuracy of the authentication will be lowered. In addition, compatibility with conventional contact-type authentication devices also becomes difficult accordingly.

The present disclosure has been made in view of such circumstances, and an object thereof is to provide a contactless biometric authentication device, a contactless biometric authentication system, and a contactless biometric authentication method which can perform authentication accurately.

A contactless biometric authentication device according to the present disclosure provides an insertion chamber which includes an opening on the side and a space into which an authenticator's finger is inserted from the opening to the far side; a shooting device which is installed at a position to capture the ventral side of the finger inserted into the insertion chamber; a first light source which is installed at a position on the far side of the shooting device in the insertion chamber and emits light toward the shooting device, the light being blocked by the inserted finger; a second light source which is provided at a higher position than a height at which the finger is inserted, emits light within a predetermined range, including the shooting device, when the light from the first light source is blocked by the finger, the light being absorbed by a blood vessel of the finger; and a reflection surface which is provided in the insertion chamber and receives and reflects the light from the second light source, wherein a position and direction of the reflection surface are adjusted to reflect the light from the second light source in a proportion corresponding to the height of the inserted finger when the light from the first light source is blocked by the finger, and the shooting device captures an image including the light reflected from the reflection surface, and the ventral side of the inserted finger.

According to the present disclosure, it is possible to perform accurate contactless authentication.

Other configurations and effects not specifically described above will become apparent from the following description of the embodiments.

### BRIEF DESCRIPTION OF THE DRAWINGS

FIG. 1 is a diagram illustrating the schematic configuration of a contactless biometric authentication system according to Embodiment 1.

FIG. 2 is a cross-sectional view of a contactless biometric authentication device according to Embodiment 1 as viewed from the side.

FIG. 3 is a diagram illustrating an example of the configuration of an information processing device.

FIG. 4 is a flowchart illustrating an example of personal authentication processing.

FIGS. 5A to 5F are diagrams explaining the principle of finger height detection processing.

FIGS. 6A to 6F are diagrams illustrating an example of correction processing.

FIGS. 7A to 7C are diagrams explaining the principle of finger detection processing.

FIG. 8 is a diagram illustrating an example of the shooting range of a subject captured by a shooting device of a conventional device and the shooting range of a subject captured by a shooting device according to the present embodiment.

FIG. 9 is a graph showing the relationship between the size of a cylinder as a subject captured with a shooting device of a conventional device and the size of a cylinder captured by a shooting device with a long focal length, which is the experimental result of the present inventors.

FIG. 10 is a diagram illustrating an example of normalization processing.

FIG. 11 is a diagram illustrating an example of region extraction processing.

FIG. 12 is a cross-sectional view of the contactless biometric authentication device as viewed from the side.

FIG. 13 is a diagram illustrating an example of an information processing device erroneously recognizing the structure in the background as part of the finger.

FIG. 14 is a flowchart illustrating an example of finger contour correction processing.

FIG. 15 is a diagram illustrating an example of estimating the contour on the base side of the finger by finger contour correction processing.

FIGS. 16A to 16F are diagrams illustrating an example of a contactless biometric authentication device according to Embodiment 2 as viewed from the side of the opening of the insertion chamber and an example of a captured image captured by the contactless biometric authentication device.

FIGS. 17A to 17F are diagrams illustrating an example of a contactless biometric authentication device according to Embodiment 3 as viewed from the side of the opening of the insertion chamber and an example of a captured image captured by the contactless biometric authentication device.

FIGS. 18A and 18B are diagrams illustrating the configuration of an additional second light source according to Embodiment 4.

FIGS. 19A and 19B are cross-sectional views of the contactless biometric authentication device according to Embodiment 5 as viewed from the fingertip direction when the finger is inserted.

### DETAILED DESCRIPTION

Embodiments of the present disclosure will be described with reference to the drawings while showing specific examples.

### Embodiment 1

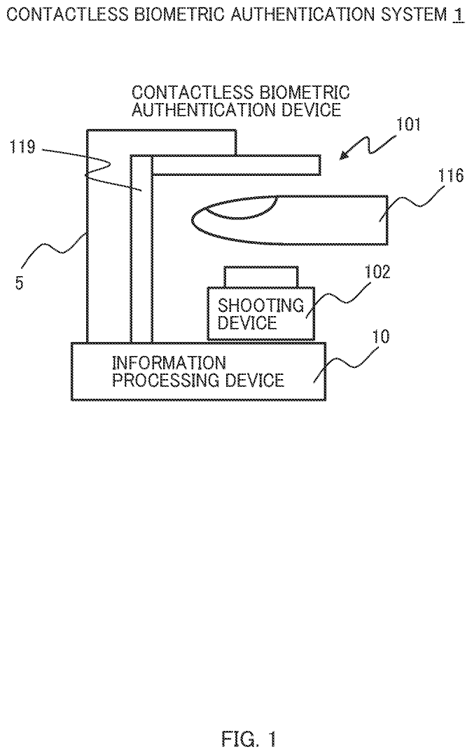

FIG. 1 is a diagram illustrating the schematic configuration of a contactless biometric authentication system 1 according to Embodiment 1. The contactless biometric authentication system 1 is configured to include a contactless biometric authentication device 101 and an information processing device 10. The contactless biometric authentication system 1 is an information processing system that captures an image of the veins of the authentication user's (hereinafter authenticator's) finger by irradiating their finger with near-infrared rays, and identifies the authenticator.

The contactless biometric authentication device 101 includes an insertion chamber 119 equipped with multiple light sources (not illustrated) that emit near-infrared light to the finger 116 of the authenticator when the finger 116 is inserted with its ventral side facing downwards, and a shooting device 102.

The shooting device 102 captures an image (hereinafter referred to as an authentication image) of the veins of the inserted finger 116, utilizing the fact that the near-infrared light emitted from the contactless biometric authentication device 101 is easily absorbed by the veins in the finger 116.

The information processing device 10 performs authentication by recognizing the vein pattern of the finger 116 in the authentication image captured by the shooting device 102, and comparing the recognized blood vessel pattern with the image of the blood vessel pattern of the pre-registered authenticator (referred to as a template image). The information processing device 10 is communicably coupled to the contactless biometric authentication device 101 via a communication line 5 or the like.

Contactless Biometric Authentication Device

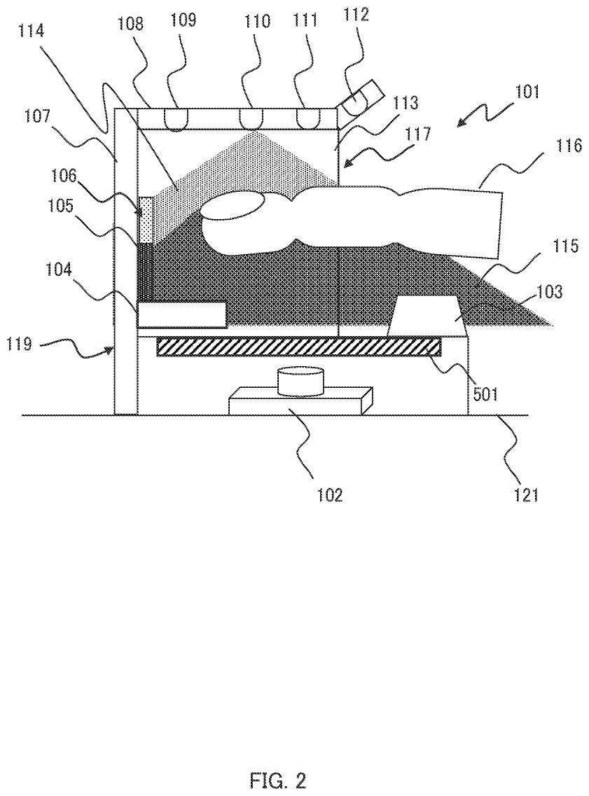

FIG. 2 is a cross-sectional view of a contactless biometric authentication device 101 according to Embodiment 1 as viewed from the side.

The contactless biometric authentication device 101 is fixed, for example, on a predetermined installation surface 121. The contactless biometric authentication device 101 includes an insertion chamber 119 that forms an insertion space for inserting the authentication target finger 116 (one finger in this case) of the authenticator in a substantially horizontal direction by having an opening 117 on the side. The authenticator's finger 116 is inserted from the opening 117 with its ventral side facing downward.

The insertion chamber 119 includes a rear wall 107 that forms the wall on the far side (the side where the fingertip 116 is inserted), two side walls 113 that form the walls on the left and right sides (the direction substantially perpendicular to the insertion direction of the finger 116), a plate-shaped ceiling 108 that forms a ceiling, and the opening 117 on the front side. The rear wall 107 and each side wall 113 are erected substantially vertically with respect to the installation surface 121.

At the lower portion of the insertion chamber 119, a shooting device 102 is provided to capture vascular images of the veins of the front fingertip inserted into the insertion chamber 119. The shooting direction of the lens of the shooting device 102 is set upwards to capture the front fingertip 116 inserted into the chamber.

Furthermore, an optical filter 501 is provided above the shooting device 102 and below the inserted finger 116. The shooting device 102 captures an image of the finger 116 captured through the optical filter 501.

At the ceiling 108 of the insertion chamber 119, a first light source 109 and multiple second light sources 110, 111, and 112 are provided. The first light source 109 and second light sources 110, 111, and 112 are provided at a position higher than the height at which finger 116 is inserted, at least.

The first light source 109 emits directional (axial) near-infrared light to detect insertion of the finger 116 into the insertion chamber 119. The first light source 109 is positioned on the far side of the insertion chamber 119 from the shooting device 102.

The irradiation direction of the near-infrared light of the first light source 109 is adjusted diagonally downward toward the side of the opening 117 facing the shooting device 102. That is, the irradiation direction of the near-infrared light from the first light source 109 is adjusted in the direction in which the direct light from the first light source 109 reaches the shooting device 102 when the finger 116 is not inserted into the insertion chamber 119.

Next, the second light sources 110, 111, and 112 emit near-infrared rays in a predetermined range (at a predetermined irradiation angle) to capture images of the veins of the finger 116 when the finger 116 is inserted into the insertion chamber 119.

The irradiation range of the near-infrared light from the second light sources 110, 111, and 112 is adjusted to widely irradiate the space below the insertion chamber 119. Specifically, the direct light is adjusted to illuminate the dorsal side of the inserted finger 116 overall and to be capable of irradiating a reflection plate 106 described later.

At the lower portion of the insertion chamber 119, there are provided a finger base-side finger rest 103 for resting the ventral side of the finger 116 at its base, and a fingertip-side finger rest 104 for resting the ventral side of the finger 116 at its fingertip. The finger base-side finger rest 103 and the fingertip-side finger rest 104 can be used for conventional contact-type authentication.

Next, a reflection plate 106 is provided on the lower side of the inner surface of the rear wall 107 of the insertion chamber 119, which reflects and receives near-infrared light. The height of this reflection plate 106 is provided within a range of height that blocks light from the second light sources 110, 111, and 112 according to the height of the inserted finger 116.

Specifically, the reflection surface of the reflection plate 106 is adjusted at a position and in a direction such that if the light from the first light source 109 is blocked by the tip of the finger 116 inserted into the insertion chamber 119, then the light from the second light sources 110, 111, and 112, in a proportion corresponding to the height of the finger 116 inserted, reaches and reflects off the reflection surface of the reflection plate 106, and the reflected light is captured by the shooting device 102. Details are described later. The reflection plate 106 is also provided to prevent direct external light from hitting the finger rest (finger base-side finger rest 103, fingertip-side finger rest 104).

Here, the operation of the contactless biometric authentication system 1 when the finger 116 is inserted into the insertion chamber 119 will be briefly described.

When the finger 116 is inserted into the insertion chamber 119, the information processing device 10 detects that the fingertip of the finger 116 has reached a predetermined position (this position in the horizontal direction varies depending on the height of the finger 116, as described later) in the insertion chamber 119 by the first light source 109. Then, the second light source 110 emits near-infrared light 114.

Most of the direct near-infrared light 114 that has reached the dorsal side of the finger 116 from the second light sources 110, 111, and 112 is blocked by the inserted finger 116, and a shadow 115 of the finger is formed in the space below the ventral side of the finger 116. However, part of the near-infrared light 114 that has reached the dorsal surface of the finger 116 (specifically, the near-infrared light 114 that has reached the part where veins exist) is blocked by the finger 116. This is because hemoglobin contained in blood absorbs the near-infrared light 114 more strongly than other parts of the body. Then, the near-infrared light 114 that has passed through the body part other than the blood vessels reaches the shooting device 102, and as a result, the shooting device 102 captures the blood vessel pattern as blackish lines. On the other hand, on the reflection surface of the reflection plate 106 of the contactless biometric authentication device 101, a dark portion 105 due to the finger shadow 115 is formed on the lower side of the reflection surface. As the height of the finger 116 increases, the upper end of the region of the dark portion 105 progresses upward.

The contactless biometric authentication system 1 of the present embodiment detects the height of the finger 116 by utilizing the fact that the part corresponding to the dark portion 105 is captured in the image (that is, the authentication image) captured by the shooting device 102. As a result, regardless of the height of the finger 116 inserted by the authenticator, the authentication image can be corrected to an image more suitable for authentication, and accurate authentication can be performed based on this corrected image. Details will be described later.

Next, the information processing device 10 will be described.

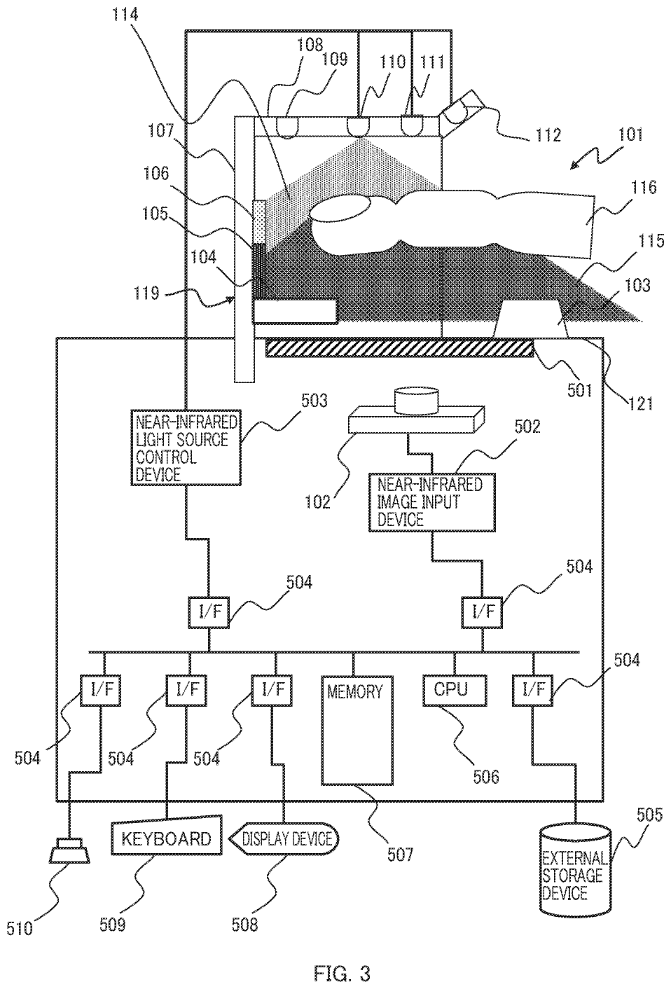

FIG. 3 is a diagram illustrating an example of the configuration of an information processing device 10.

The information processing device 10 includes a processing unit 506, such as a central processing unit (CPU), a digital signal processor (DSP), a graphics processing unit (GPU), or a field-programmable gate array (FPGA), a memory 507 such as a read only memory (ROM) or a random access memory (RAM), an external storage device 505 such as a hard disk drive (HDD) or a solid state drive (SSD), an input device 509 such as a mouse or a keyboard, a display device 508 such as a liquid crystal display or an organic electro-luminescence (EL) display, a printing device 510 such as a printer, a near-infrared ray light source control device 503 for turning on/off and adjusting the luminance of each light source, a near-infrared image input device 502, and a communication interface 504 including a communication module and the like. The shooting device 102 and an optical filter 501 may be provided inside the information processing device 10, or may be configured as components of the contactless biometric authentication device 101 as described above. Further, the contactless biometric authentication device 101 and the information processing device 10 may be configured as a single device.

The near-infrared image input device 502 of the information processing device 10 converts electrical signals of an image captured by the shooting device 102 into image data (digital data), and records the converted image data in the memory 507 via the communication interface 504.

The processing unit 506 executes a predetermined analysis program stored in the memory 507, and this analysis program analyzes the image recorded in memory 507 and detects that the light from the first light source 109 has been blocked by the authenticator's finger 116. Then, the processing unit 506 executes a predetermined control program stored in the memory 507. This control program instructs the near-infrared ray light source control device 503 via the communication interface 504 to emit near-infrared rays from the second light sources 110, 111, and 112.

Thereafter, the processing unit 506 generates data of an image of the authenticator's finger 116 (that is, an authentication image) that has been captured while the second light sources 110, 111, and 112 are emitting near-infrared rays, and records it in the memory 507. The processing unit 506 performs personal authentication by comparing this authentication image with the template image of the person prerecorded in the external storage device 505. The processing unit 506 outputs information on the result of personal authentication to the printing device 510 or to the display device 508, based on instructions from the input device 509.

Next, processing performed by the contactless biometric authentication system 1 will be described.

Personal Authentication Processing

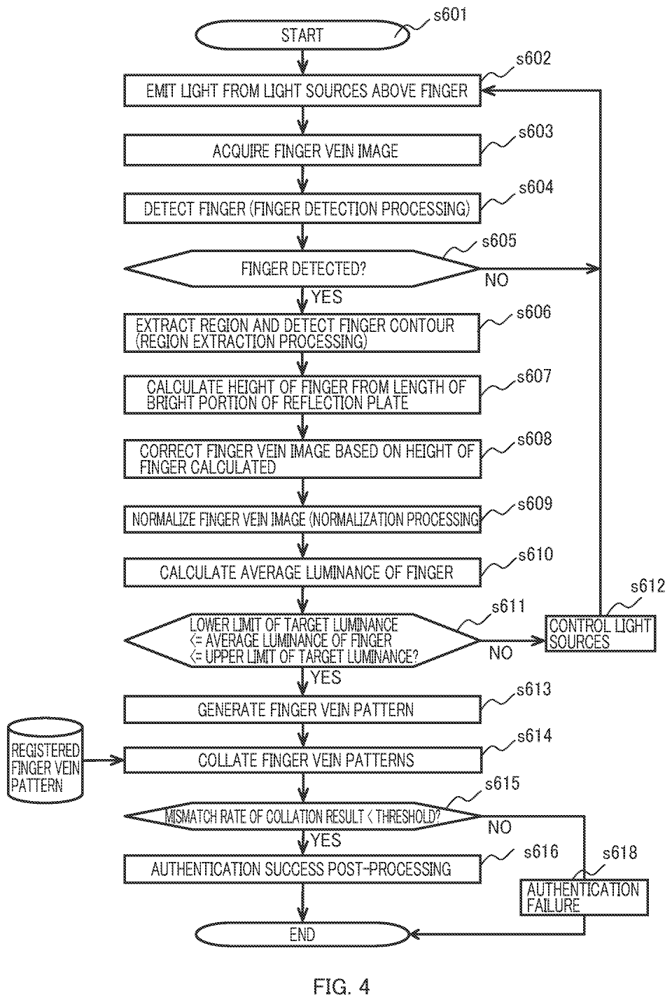

FIG. 4 is a flowchart illustrating an example of processing related to personal authentication (hereinafter referred to as personal authentication processing) performed by the information processing device 10 and the like.

When the authenticator inserts the finger 116 into the contactless biometric authentication device 101 (s601), the light from the first light source 109 is blocked by the finger 116, and the image is transmitted from the shooting device 102 to the information processing device 10. The information processing device 10 detects from the image that the authenticator's finger 116 has been inserted into the contactless biometric authentication device 101.

Then, the information processing device 10 instructs the contactless biometric authentication device 101 to emit near-infrared rays from the second light sources 110, 111, and 112 (s602).

When acquiring an image (authentication image) captured by the shooting device 102 in which the veins of the authenticator's finger 116 are made visible due to the second light sources 110, 111, and 112 (s603), the information processing device 10 executes finger detection processing s604 to detect whether or not the authentication image is an image of the finger 116 inserted in the insertion chamber 119. Details of the finger detection processing s604 will be described later.

If the authentication image is not an image of the finger 116 inserted into the insertion chamber 119 (s605: NO), the information processing device 10 repeats the processing of s602. If the authentication image is an image of the finger 116 inserted into the insertion chamber 119 (s605: YES), the information processing device 10 executes the process of s606.

In s606, the information processing device 10 extracts only a portion of the authentication image that is necessary for authentication, and performs region extraction processing s606 to detect the contour of the finger in the authentication image. Details of the region extraction processing s606 will be described later.

Then, the information processing device 10 executes finger height detection processing s607 to calculate the height of the finger from the size of the bright portion (the portion other than the dark portion 105) of the reflection plate 106 appearing in the authentication image.

Fingertip Height Detection

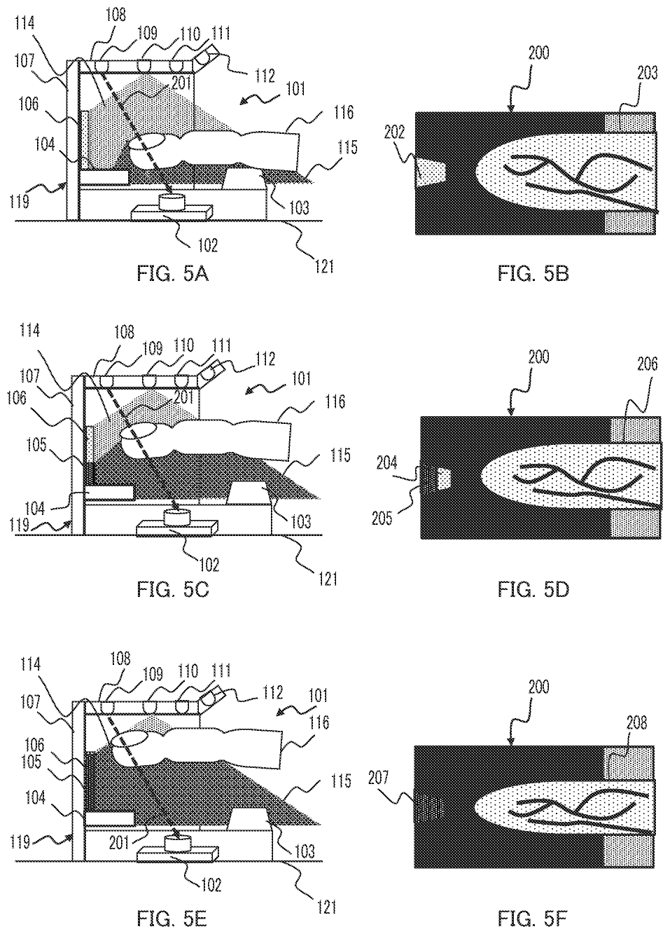

Here, FIGS. 5A to 5F are diagrams explaining the principle of the finger height detection processing s607.

First, FIG. 5A shows a case (first case) in which the finger 116 is inserted into a low position of the insertion chamber 119 of the contactless biometric authentication device 101. In this case, as shown in the figure, the fingertip of the finger 116 is on the optical axis center line 201 of the near-infrared light emitted from the first light source 109 to the shooting device 102. Therefore, the direct near-infrared light from the first light source 109 does not appear in the image captured by the shooting device 102. On the other hand, regarding the direct near-infrared light 114 from the second light source 110, the finger 116 is at a lower position of the insertion chamber 119. Therefore, the finger shadow 115, which is a space below the ventral side of the finger formed by the near-infrared light 114 reaching the dorsal side of the finger 116 and being blocked, is small. As a result, there is no dark portion due to the finger shadow 115 on the reflection plate 106.

FIG. 5B is a diagram illustrating an example of an image captured by the shooting device 102 in the first case. This captured image 200 shows a finger region 203. Here, since the finger 116 blocks the emission of the near-infrared light from the second light source 110 at a low position in the insertion chamber 119 as described above, the finger shadow 115 in the insertion chamber 119 is small. Therefore, in the captured image 200, a bright region 202 corresponding to the reflection surface of the reflection plate 106, which is brightly lit throughout, appears.

Next, FIG. 5C shows a case (second case) in which the finger 116 is inserted into the insertion chamber 119 of the contactless biometric authentication device 101 at approximately an intermediate height (an intermediate height between the installation surface 121 and the ceiling 108). In this case, as shown in the figure, the fingertip of the finger 116 is on the optical axis center line 201 of the near-infrared light emitted from the first light source 109 to the shooting device 102, and therefore, the near-infrared light from the first light source 109 does not appear in the image captured by the shooting device 102. On the other hand, the finger 116 is located at the middle height of the insertion chamber 119, and the first light source 109 is located on the far side of the insertion chamber 119 relative to the shooting device 102 in the present embodiment. Therefore, part of the direct near-infrared light 114 from the second light source 110 reaches the dorsal side of the finger 116 and is blocked, and as a result, the finger shadow 115 is formed below the finger 116. Therefore, the dark portion 105 due to the finger shadow 115 is also formed on a part of the lower side of the reflection surface of the reflection plate 106. On the other hand, the remaining surface of the reflection surface of the reflection plate 106 is directly irradiated with the near-infrared light from the reflection plate 106, and this surface receives the near-infrared light and reflects the near-infrared light.

FIG. 5D is a diagram illustrating an example of an image captured by the shooting device 102 in the second case. A finger region 206 is shown in this captured image 200. The shape of this finger region 206 is similar to the finger region 203 shown in FIG. 5B, but the size thereof becomes smaller depending on the height of the finger 116 from the shooting device 102, since the height of the finger 116 is higher than the shooting device 102. Additionally, the authenticator's finger 116 blocks the irradiation of the near-infrared light from the second light source 110 at about the middle height of the insertion chamber 119 as described above. Therefore, a dark portion 105 is formed by the finger shadow 115 on a part of the surface on the lower side of the reflection surface of the reflection plate 106, while the remaining upper reflection surface is directly irradiated with the near-infrared light reflected by the reflection plate 106. Therefore, the captured image 200 includes a dark region 205 corresponding to the dark portion 105 of the reflection plate 106 and a bright region 204 directly irradiated with the near-infrared light reflected by the reflection plate 106.

Next, FIG. 5E shows a case (third case) in which the finger 116 is inserted into the insertion chamber 119 of the contactless biometric authentication device 101 at a high position (a position close to the ceiling 108). In this case, as shown in the figure, the fingertip of the finger 116 is on the optical axis center line 201 of the near-infrared light emitted from the first light source 109 to the shooting device 102, and therefore, the near-infrared light from the first light source 109 does not appear in the image captured by the shooting device 102. On the other hand, the finger 116 is located at a high position in the insertion chamber 119 (near second light source 110). Therefore, most of the direct near-infrared light 114 from the second light source 110 reaches the dorsal side of the finger 116 and is blocked, and thereby the finger shadow 115 is formed. As a result, a dark portion 105 due to the finger shadow 115 is formed on the entire reflection surface of the reflection plate 106.

FIG. 5F is a diagram illustrating an example of an image captured by the shooting device 102 in the third case. A finger region 208 is shown in this captured image 200. The shape of this finger region 208 is similar to the finger region 203 shown in FIG. 5D, but the size thereof becomes smaller depending on the height of the finger 116 from the shooting device 102, since the height of the finger 116 is higher than the shooting device 102. In addition, the authenticator's finger 116 blocks the irradiation of the near-infrared light from the second light source 110 at a high position of the insertion chamber 119 as described above. Therefore, a dark portion 105 by the finger shadow 115 is formed on the entire surface of the reflection plate 106. Therefore, the captured image 200 only includes a dark region 207 corresponding to the dark portion 105 of the reflection plate 106.

As described above, in the captured image captured by the shooting device 102 when the finger 116 is inserted, the area of the dark portion 105 (area of the bright portion) on the reflection plate 106 has a certain correlation (for example, a proportional relation) with the insertion height of the finger 116 at that time.

Thus, the information processing device 10 calculates in advance a correlation formula between the size of the dark portion 105 on the captured image and the insertion height of the finger 116 by experimentation before executing the finger height detection processing s607.

For example, the information processing device 10 creates a correlation formula between the number of pixels on the authentication image of the dark portion 105 of the reflection plate (or the bright portion of the reflection plate) and the insertion height of the finger 116.

Thereafter, in the finger height detection processing s607, the information processing device 10 calculates the size of the dark portion 105 on the captured image captured by the shooting device 102, and calculates the height of the authenticator's finger 116 based on the calculated size. For example, the information processing device 10 calculates the number of pixels of the dark portion 105 of the reflection plate 106 (or the bright portion of the reflection plate 106) on the authentication image. The information processing device 10 can calculate the current insertion height of the authenticator's finger 116 by substituting the number of pixels of the dark portion 105 (or the bright portion of the reflection plate 106) into the correlation formula described above.

Note that, preferably, the second light sources 110, 111, and 112 are arranged such that they are aligned in a row from the opening 117 toward the rear wall 107 of the insertion chamber 119 so as to allow the finger 116 to be inserted into the center of the insertion chamber 119 and to irradiate the central portion of the finger 116 uniformly.

In addition, among the multiple second light sources 110, 111, and 112, the second light source 110 on the fingertip side needs to be arranged at a position that allows for irradiation of the coverage including the fingertip with sufficient luminance so as to reliably detect the insertion of the finger 116. If the second light source 110 on the fingertip side is brought too close to the rear wall 107, the light emitted from the second light source 110 on the fingertip side directly reaches and is reflected on the reflection plate 106 of the real wall 107. This reflected light appears as bright spots in the image captured by the shooting device 102, which may interfere with capturing a clear vascular image. Therefore, it is preferable to arrange the second light source 110 on the fingertip side away from the rear wall 107 to a position where no bright spot occurs.

Further, the authenticator's finger 116 differs in the ease with which infrared rays transmit therethrough depending on its position. Thus, each of the second light sources 110, 111, and 112 is preferably configured such that the luminance can be controlled independently by the control of the near-infrared ray light source control device 503, and the brightness can be adjusted so that the average luminance of the finger 116 matches a predetermined target luminance. Furthermore, in the case of using a light source that diffuses light extensively as the second light sources 110, 111, and 112, directly irradiated light from the second light sources 110, 111, and 112 is reflected on the rear wall 107 and the reflected light may appear as bright spots in the image captured by the shooting device 102. Therefore, it is desirable that the second light sources 110, 111, and 112 use highly directional light sources that do not diffuse light.

Furthermore, preferably the position of the first light source 109 for detecting the position of the fingertip is such that the light emitted toward the shooting device 102 is at a downward diagonal angle. Therefore, it is preferable that the first light source 109 be aligned with the second light sources 110, 111, and 112 but as far away as possible from the second light sources 110, 111, and 112. However, if the first light source 109 is too far away from the second light sources 110, 111, and 112, the first light source 109 will come closer to the rear wall 107. Then, there is a possibility that the direct light from the first light source 109 is reflected on the inner surface of the rear wall 107, and the reflected light appears as bright spots in the captured image by the shooting device 102, which could hinder capturing a clear blood vessel image. Therefore, it is desirable to arrange the first light source 109 at a position where no bright spots occur (a position where light of a predetermined intensity or more is not reflected on the inner surface of the rear wall 107) by spacing it a certain distance from the rear wall 107 as well.

Furthermore, if the first light source 109 for detecting the position of the authenticator's fingertip is made too bright, it becomes difficult to determine in the captured image whether the light source is visible or the fingertip appears bright due to luminance saturation. Therefore, it is desirable that the first light source 109 emit a constant intensity of light, which is the minimum intensity of light such that the light source appears in the captured image with the maximum luminance of the shooting device 102.

Furthermore, there are cases where using a light source that diffuses light extensively as the first light source 109 for detecting the position of the authenticator's fingertip can hinder the capturing of a clear finger vascular image by causing the irradiated light to directly reach and reflect off the rear wall 107, with the reflected light being captured as bright spots in the captured image by the shooting device 102. Therefore, as the first light source 109, it is desirable to use a highly directional light source that does not diffuse light.

Subsequently, as shown in FIG. 4, the information processing device 10 executes correction processing s608 to correct distortion of the shape of the finger in the authentication image.

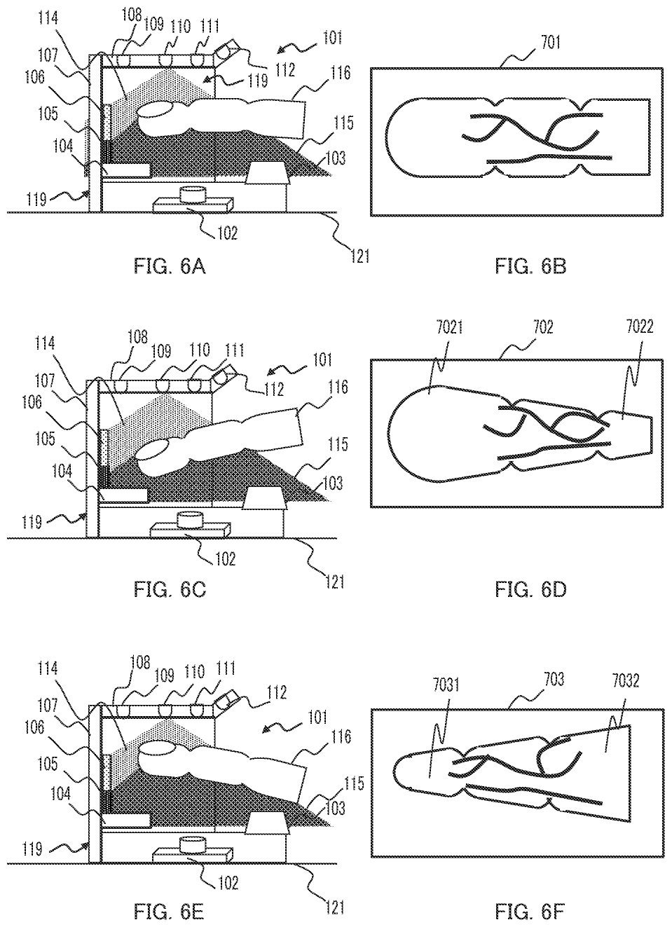

FIGS. 6A to 6F are diagrams illustrating an example of correction processing s608.

First, as shown in FIG. 6A, when the finger 116 is properly inserted parallel to the installation surface 121, the authentication image 701 is an image of the veins captured from the front without distortion, as shown in FIG. 6B.

However, as shown in FIG. 6C, when the finger 116 is inserted with the fingertip facing downwards (the finger 116 is tilted toward the installation surface 121 in the fingertip direction), the authentication image 702 becomes a distorted image where the width of the finger at the fingertip side 7021 is wider and the width of the finger at the base side 7022 is narrower, as shown in FIG. 6D.

In addition, as shown in FIG. 6E, when the finger 116 is inserted with the fingertip facing upwards (the finger 116 is tilted toward the ceiling 108 in the fingertip direction), the authentication image 703 becomes a distorted image where the width of the finger at the fingertip side 7031 is narrower and the width of the finger at the base side 7032 is wider, as shown in FIG. 6F.

In this way, when the insertion direction of finger 116 is not parallel to the installation surface 121 and the authentication image 702 is distorted, the information processing device 10 recognizes the contour shapes of the distorted authentication images 702 and 703 (for example, recognizes them as trapezoidal shapes), and performs trapezoidal distortion correction so that the plane figures become the same as the contour shape of the pre-registered undistorted authentication image 701, based on the height of the finger 116 calculated in s607.

Next, as shown in FIG. 4, the information processing device 10 executes normalization processing s609 to normalize the width of the finger 116. Specifically, the information processing device 10 expands or reduces an authentication image based on the contour shape information of the finger 116 recognized in s608 so that the average width of the finger 116 in the image becomes a predetermined reference width. Details of the normalization processing s609 will be described later.

The information processing device 10 then calculates the average luminance of the authentication image normalized in the normalization processing s609 (s610).

The information processing device 10 determines whether or not the average luminance of the authentication image is equal to or greater than a predetermined lower limit value and equal to or less than a predetermined upper limit value (s611). If the average luminance is equal to or greater than the predetermined lower limit value and equal to or less than the predetermined upper limit value (s611: YES), the information processing device 10 executes the processing of s613.

On the other hand, if the average luminance is less than the predetermined lower limit value or exceeds the predetermined upper limit value (s611: NO), the information processing device 10 adjusts the average luminance of the authentication image (s612). Specifically, the information processing device 10 increases the light intensity values of the second light sources 110, 111, and 112 by a predetermined value if the average luminance is less than the predetermined lower limit value, and then executes the processing of s602. On the other hand, if the average luminance exceeds the predetermined upper limit value, the information processing device 10 reduces the light intensity values of the second light sources 110, 111, and 112 by a predetermined value, and then executes the processing of s602.

Otherwise, in s613, the information processing device 10 generates a pattern image of blood vessels (veins) of the finger 116 based on the authentication image corrected by each process up to s610.

The information processing device 10 checks the generated blood vessel pattern image with the template image registered in the external storage device 505, and calculates the degree of mismatch in the collation as a collation score (s614).

For example, the information processing device 10 performs template matching between the template image and the blood vessel pattern image generated in s613. The information processing device 10 performs a comparison between each image that has been slightly shifted for each pixel of the pattern image of the blood vessels generated at s613 and the template image, and calculates the number of unmatched pixels when the number of matching pixels is the highest as a mismatching rate (collation score).

The information processing device 10 determines whether or not the collation score calculated in s614 is equal to or less than a predetermined threshold (s615). If the collation score is equal to or less than the predetermined threshold (s615: YES), the information processing device 10 executes the processing of s616. If the collation score exceeds the predetermined threshold (s615: NO), the information processing device 10 executes the processing of s618.

In s618, the information processing device 10 displays error information indicating that the authentication has failed, and ends the personal authentication processing.

Otherwise, in s616, the information processing device 10 displays information indicating that the authentication has been successful, and ends the personal authentication processing in order to execute the subsequent predetermined processing.

Finger Detection Processing

In the finger detection processing s604, the information processing device 10 may detect the insertion of a finger by determining whether the luminance at a predetermined position in the authentication image (for example, the central portion, which is surely shaded by the finger 116 and has a high luminance) exceeds a predetermined threshold, but may also perform a detection process as described below.

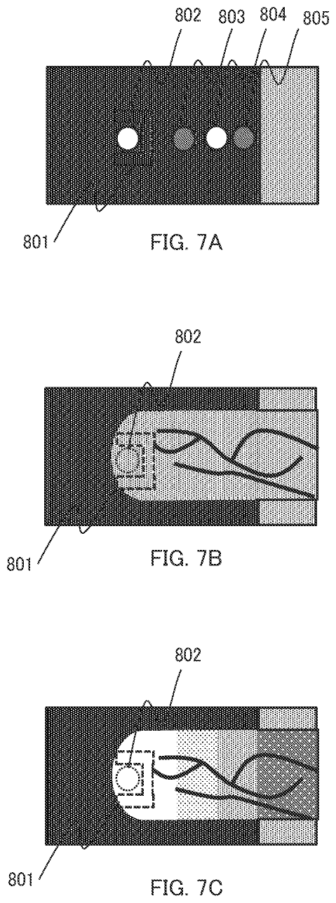

FIGS. 7A to 7C are diagrams explaining the principle of finger detection processing s604.

First, FIG. 7A is an example of a captured image (authentication image) captured with the finger 116 not inserted. This captured image 800 includes a bright region 802 where the light from the first light source 109 is captured and regions 803, 804, and 805 where the light from the second light sources 110, 111, and 112 are captured. Note that in this case, only the second light source 111, among the three second light sources 110, 111, and 112, is turned on, so that only one region 804 is bright, while the other regions 803 and 805 are somewhat dark. That is, the luminance of the bright region 802 and the corresponding region 804 is maximized. In addition, the region 801 surrounding the bright region 802 is a dark region.

FIG. 7B is an example of a captured image captured with the second light sources 110, 111, and 112 emitting near-infrared rays at the target luminance and the finger 116 inserted. In this captured image 800, there is no bright region based on the light of each light source. That is, in the captured image 800, there is no portion with the maximum luminance, including the region 802 corresponding to the first light source 109 (the region corresponding to the fingertip) and the surrounding region 801 thereof.

FIG. 7C is another example of a captured image captured with the second light sources 110, 111, and 112 emitting near-infrared rays at the target luminance and the finger 116 inserted. In this captured image 800, there is no bright region based on the second light sources 110, 111, and 112. However, the region 802 corresponding to the first light source 109 is bright even though the finger 116 is inserted because the fingertip is easily transmissive of light and thus experiences luminance saturation.

That is, it is impossible to determine whether this bright region 802 exists because the light from the first light source 109 has reached it (that is, the finger 116 is not held over it) or because of luminance saturation even though the finger 116 is held over it. However, if the presence of the bright region 802 is due to luminance saturation, then the surrounding region 801 of the region 802 corresponding to the first light source 109 should also be a bright region due to orbital saturation.

Therefore, in the finger detection processing s604, the information processing device 10 not only determines whether the luminance of the region 802 corresponding to the first light source 109 is above a predetermined threshold (in this case, the maximum luminance), but also whether the luminance of the surrounding region 801 is above the threshold, and determines whether the finger 116 has been inserted or not.

For example, in the case of FIG. 7C, the information processing device 10 detects that the region 802 corresponding to the first light source 109 and the surrounding region 801 also have the maximum luminance, and determines that the finger is inserted. On the other hand, in the case of FIG. 7A, the information processing device 10 determines that the finger is not inserted because the region 802 corresponding to the first light source 109 has the maximum luminance, but the surrounding region 801 does not have the maximum luminance.

Note that in FIGS. 7A-7C, the surrounding region 801 of the region 802 corresponding to the first light source 109 does not include the surrounding region at the tip of the finger. This is because such a region tends to have the maximum luminance due to reflected light from the rear wall 107 when the light from the first light source 109 becomes intense. However, the information processing device 10 may detect the luminance of the entire periphery of the region 802 without excluding such a region on the fingertip side from the surrounding region 801.

As described above, the information processing device 10 detects not only the luminance of the irradiation region of light from the first light source 109 in the captured image but also the luminance of the surroundings and the luminance of the second light sources 110, 111, and 112 in order to identify whether the finger 116 is inserted or not.

Normalization Processing

The lens of the shooting device 102 of the contactless biometric authentication device 101 should preferably have a longer focal length than the lens of the shooting device in a conventional contact-type authentication device (hereinafter referred to as the “conventional device”) with a configuration and structure similar to those of the contactless biometric authentication device 101. This is because the height of the finger 116 inserted by the authenticator is not constant in the case of a contactless authentication device such as the contactless biometric authentication device 101 of the present embodiment. That is, if the focal length is increased, the subject range can be widened, and the change in the captured image caused by the change in the distance to the subject (the height of the finger 116) can be reduced.

However, by doing so, the contour of the finger in the captured image differs from that of the finger in the authenticator's template image obtained with the conventional device, resulting in inconvenience such as the inability to reuse the template image obtained with the conventional device.

This point will be specifically described below.

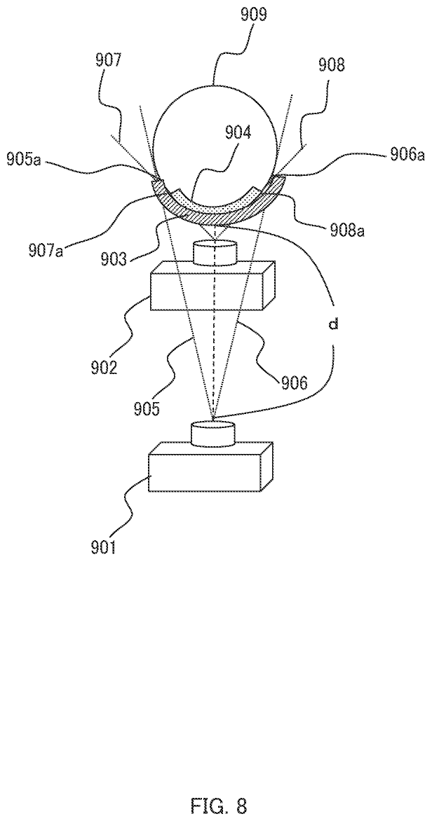

FIG. 8 is a diagram illustrating an example of the shooting range of a subject captured by a shooting device of a conventional device and the shooting range of a subject captured by a shooting device 102 according to the present embodiment.

First, the shooting device 902 of the conventional device is arranged at a position separated from the surface of the capture target cylindrical object 909 (assuming a finger) by the focal length of the lens of the shooting device 902 of the conventional device. The shooting range 904 of the shooting device 902 of the conventional device for the surface of the cylindrical object 909 has two points of contact 907a and 908a on the cylindrical object 909 as endpoints, which are on two tangents 907 and 908 that form a predetermined angle, drawn from the lens position of the shooting device 902 of the conventional device onto the surface of the cylindrical object 909.

On the other hand, the lens 901 of the shooting device 102 in the present embodiment has a longer focal length (a predetermined capture distance d) than that of the shooting device 902 of the conventional device, so that the distance between the shooting device 102 and the surface of the cylindrical object 909 also becomes longer than in the case of the shooting device 902 of the conventional device. Then, the shooting range 903 of the shooting device 102 according to the present embodiment for the surface of the cylindrical object 909 also becomes wider than the shooting range 904 of the shooting device 902 of the conventional device. That is, the shooting range 903 of the shooting device 102 according to the present embodiment has two wider points of contact 905a and 906a on the cylindrical object 909 as endpoints, which are on two tangents 905 and 906 that form greater angle, drawn from the lens position of the shooting device 102 onto the surface of the cylindrical object 909.

As described above, when authentication is performed by the contactless biometric authentication device 101 of the present embodiment using a template image collected using the shooting device of the conventional device, authentication of the authentication image does not operate normally.

For example, if the blood vessel pattern image is normalized with respect to the width of the finger 116 in s608, the size of the normalized image will not match the size of the template image.

The present inventors have found that there is a certain linear relationship between the width of the subject by the shooting device of the conventional device and the width of the subject by the shooting device 102 of the present embodiment.

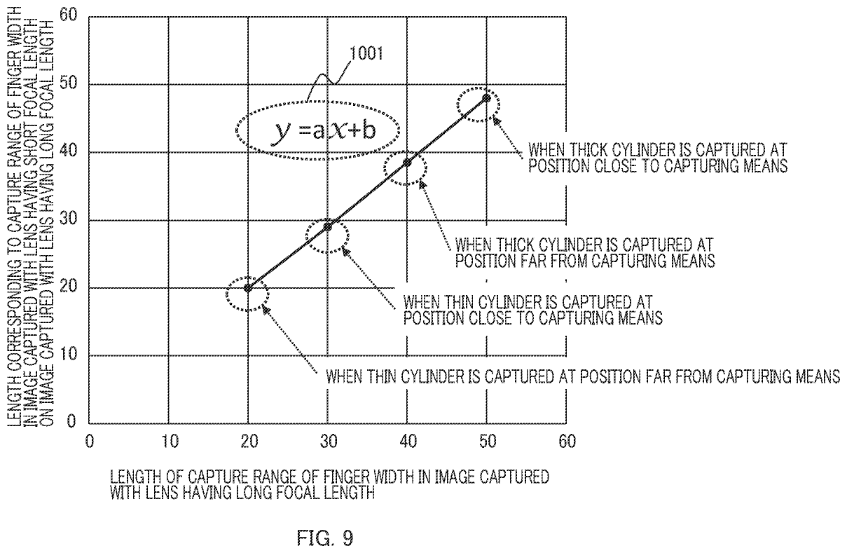

FIG. 9 is a graph showing the relationship between the size (width) of a cylinder (shown in FIG. 8) as the subject captured by the shooting device of the conventional device and the size (width) of a cylinder captured by the shooting device 102 having a long focal length (the shooting device 102 of the present embodiment) based on experiments performed bye present inventors. As shown in the figure, the relationship between the two widths is a linear relationship represented by a linear equation 1001 regardless of the thickness of the cylinder and the distance between each shooting device and the cylinder.

Therefore, in the normalization process s609, the information processing device 10 uses the linear equation 1001 to correct the focal length of the lens as described below.

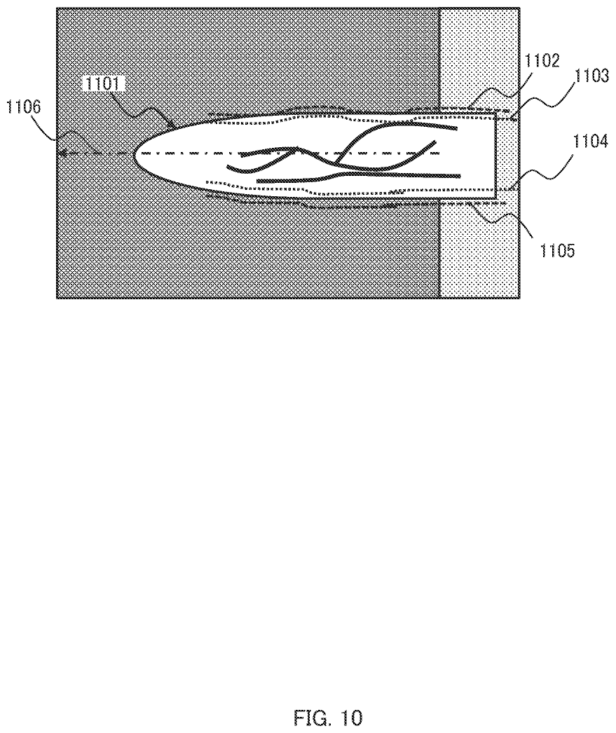

FIG. 10 is a diagram illustrating an example of normalization processing s609. First, the information processing device 10 calculates the average width of the finger based on contour lines 1102 and 1105 of both the left and right sides of the finger extracted from finger region 1101 in the authentication image.

For example, regarding each point in a continuous line on the image centerline 1106 (the insertion direction of the finger in the contactless biometric authentication device 101) of the authentication image in the horizontal direction, the information processing device 10 searches for changes in luminance of each point toward the vertical direction, starting from that point, and identifies the point of change where the luminance of adjacent points (pixels) changes most significantly from bright to dark. The information processing device 10 identifies the contour by connecting the identified points of change in the horizontal direction. Then, the information processing device 10 calculates the (average) width of the finger in the image captured by the conventional shooting device from the calculated average width of the finger and the above-described linear equation 1001. Then, the information processing device 10 calculates corrected finger contours 1103 and 1104 by performing correction to narrow the width of the finger so as to match the calculated width of the finger.

Next, the region extraction processing will be explained.

Region Extraction Processing

In the conventional device, an image of the central portion of the finger excluding the fingertip region and the base (the image of the portion corresponding to the blood vessel pattern image) is sufficient as the authentication image. However, since the contactless biometric authentication device 101 of the present embodiment performs contactless-type authentication, it is necessary to acquire a finger image of a wider area than the conventional device. Therefore, the authentication image acquired by the contactless biometric authentication device 101 is incompatible with the image acquired by the conventional device, for example, the template image of the authenticator acquired by the conventional device in the past.

However, when maintaining compatibility and reusing the template image of the authenticator acquired by the conventional device, it is preferable for the information processing device 10 to extract the necessary region of the authentication image that corresponds to the template image. Therefore, the information processing device 10 of the present embodiment executes the following region extraction processing.

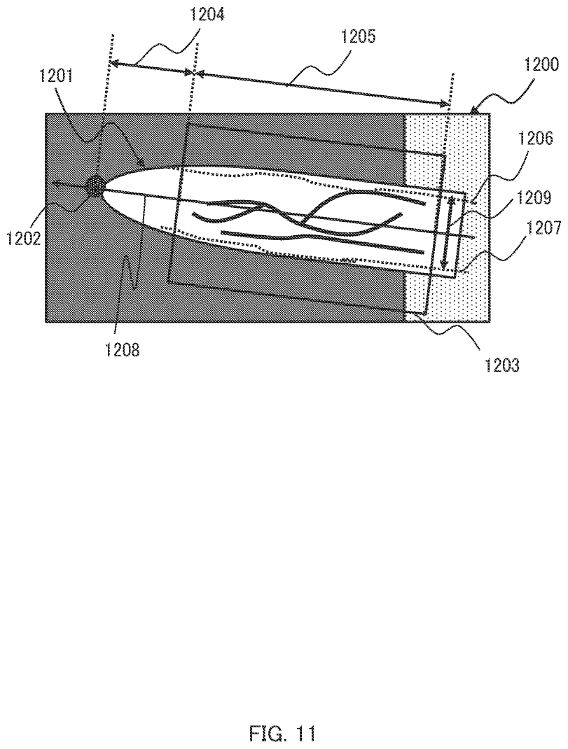

FIG. 11 is a diagram illustrating an example of region extraction processing s606.

First, the information processing device 10 recognizes contour lines 1206 and 1207 on both the left and right sides of the finger 1201 by identifying pixel portions in the authentication image 1200 in which luminance changes significantly. Then, the information processing device 10 calculates a central line 1208 that is equidistant from the recognized contour lines 1206 and 1207 on both the left and right sides.

The information processing device 10 uses the central line 1208 as a starting point to identify the tip point 1202 of the finger by identifying the point of maximum brightness-to-darkness change (point of change), where, for the continuous pixel points on the central line 1208, adjacent pixel points in the direction from the base side of the finger to the fingertip side show the greatest change in brightness.

Further, the information processing device 10 obtains the average finger width 1209 from the finger contour lines 1206 and 1207 of the authentication image 1200.

Then, the information processing device 10 multiplies the average finger width 1209 by a predetermined constant A to calculate the distance 1204 from the tip point 1202 of the finger to the rectangular region 1203 to be extracted as the authentication image.

Further, the information processing device 10 multiplies the average finger width 1209 by a predetermined constant B to calculate the longitudinal length 1205 of the rectangular region 1203 to be extracted. Note that the information processing device 10 may calculate the length in the short direction of the rectangular region 1203 to be extracted based on the aspect ratio of the pre-set image, or it may calculate the length in the short direction of region 1203 as the processing proportion longer than the maximum finger width.

Note that the position and size of the rectangular region 1203 to be extracted can be calculated based on the tip point 1202 of the finger and the average finger width 1209. This is because there is a certain degree of relationship between the width of a person's finger, the length of their finger, and the position of each joint in the length direction of the finger, which is known. Therefore, the constants A and B can be obtained empirically by aggregating the finger shape information of many people.

As described above, the information processing device 10 can appropriately extract an authentication image compatible with the template image of the conventional device.

Shape of Ceiling

In the contactless biometric authentication device 101 of the present embodiment, the shape of the ceiling 108 is modified so that the authenticator can easily check the finger position.

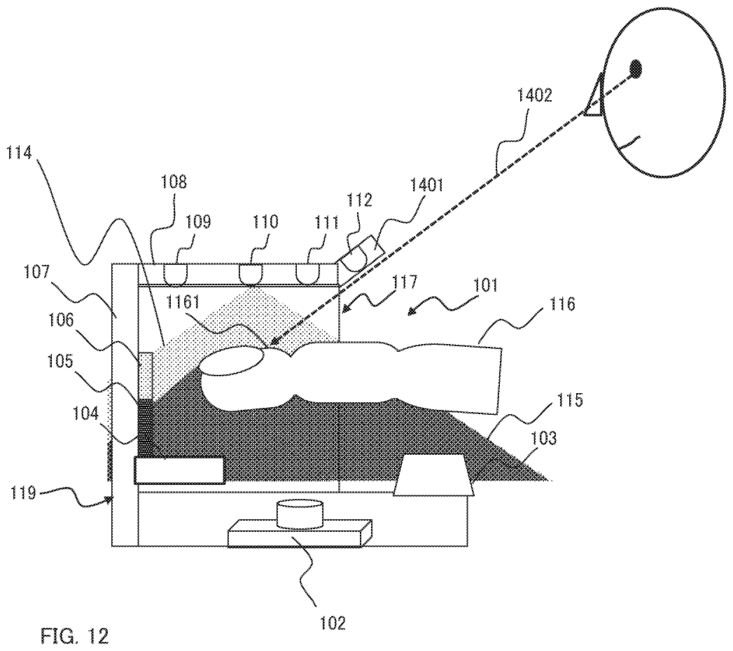

FIG. 12 is a cross-sectional view of the contactless biometric authentication device 101 as viewed from the side. For example, in the conventional device, the portion corresponding to the ceiling 108 of the contactless biometric authentication device 101 has a flat plate shape.

However, although the ceiling 108 of the contactless biometric authentication device 101 is generally in a flat plate shape, it has an upwardly extending extension 1401 at the end on the opening 117 side. This extending direction faces the authenticator's line of sight. The preferred direction of extension is such that the line of sight 1402 from the authenticator attempting to insert the finger 116 follows along the lower surface of the extension 1401 of the ceiling 1305 (lower surface of the ceiling 108), and reaches the dorsal surface 1161 of the fingertip of the finger 116 to be inserted.

This allows the authenticator to insert the finger 116 into the insertion chamber 119 while confirming the position of the finger 116 that is inserted without changing their line of sight or posture unnaturally. This makes it possible to reduce the psychological resistance of the authenticator to inserting their finger into the insertion chamber 119, which is difficult to see from the authenticator's perspective.

On the other hand, since the extension 1401 extends upward, there is a possibility that external light (such as a fluorescent lamp on the ceiling of the room) may enter the insertion chamber 119 and appear as the background of the authentication image.

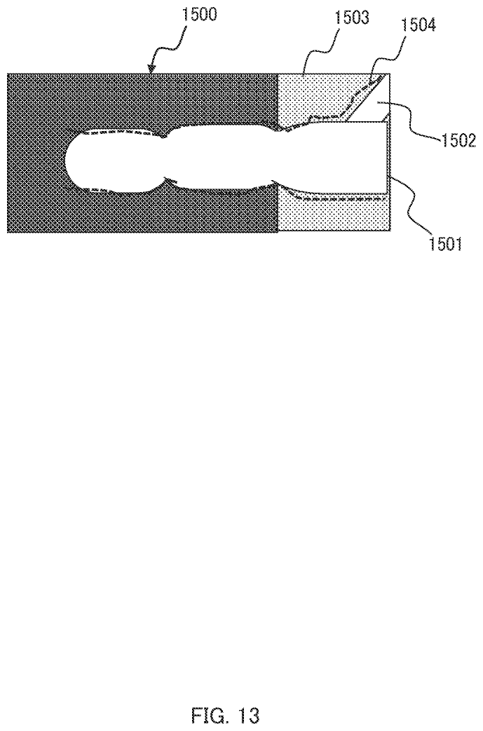

That is, as shown in FIG. 13, a background structure 1502 appears in the region 1503 on the base side 1501 of the finger in the authentication image 1500. In this case, the information processing device 10 may erroneously recognize the background structure 1502 as the finger portion. For example, the information processing device 10 recognizes an erroneous finger contour line 1504 on the base side of the finger based on both the original finger portion and the boundary lines of the background structure 1502. Such erroneous recognition of the contour of the finger occurs, for example, when the fluorescent lamp on the ceiling appears in the authentication image.

Therefore, the information processing device 10 of the present embodiment may perform the following processing in the contour extraction processing s606 to correct the contour of the finger.

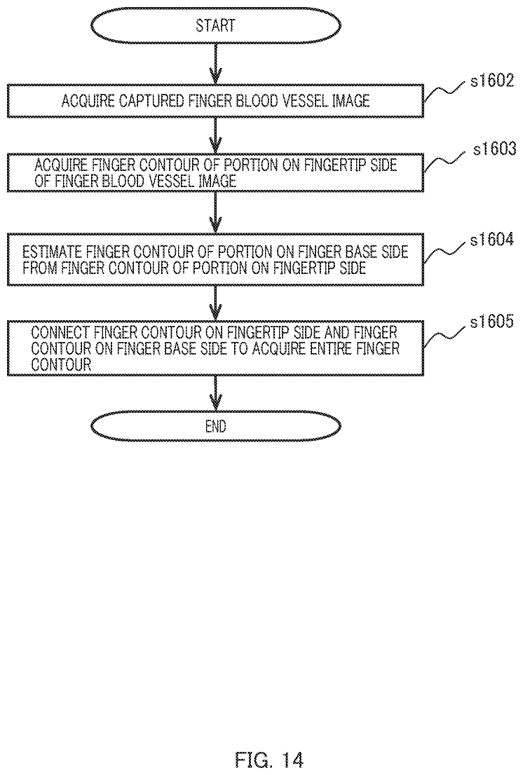

FIG. 14 is a flowchart illustrating an example of finger contour correction processing for correcting the contour of the finger in the authentication image, which is performed in the contour extraction processing s606.

First, the information processing device 10 acquires an authentication image (s1602, similar to s603 to s605 above).

The information processing device 10 recognizes the contour line of the finger on the fingertip side by identifying pixel portions in the authentication image in which the luminance changes significantly (s1603).

Then, the information processing device 10 estimates the contour of the finger on the base side based on the authentication image acquired in s1603 (s1604). Finally, the information processing device 10 connects the contour of the fingertip with the counter of the base of the finger to acquire the contour of the entire finger (s1605), after which processing terminates.

Specifically, the information processing device 10 creates in advance a trained model for estimating the contour portion of the finger on the base side from the contour image of the finger on the fingertip side. For example, the information processing device 10 collects images of the fingers of multiple individuals and divides them into images of the contour on the fingertip side and the contour on the base side. The information processing device 10 creates a trained model by executing machine learning based on teacher data that uses the contour image on the fingertip side as input data and the contour portion of the base side of the finger as correct data, estimating the contour of the finger on the base side from the contour of the finger on the fingertip side.

Note that the distinction between the regions on the fingertip side and base side in the authentication image may be made, for example, by pre-registering each region in the authentication image, or by estimating from the distribution of the contour lines of the finger.

Then, the information processing device 10 inputs the contour data of the fingertip side acquired in s1603 to the created trained model, thereby estimating the contour of the finger on the base side of the authentication image.

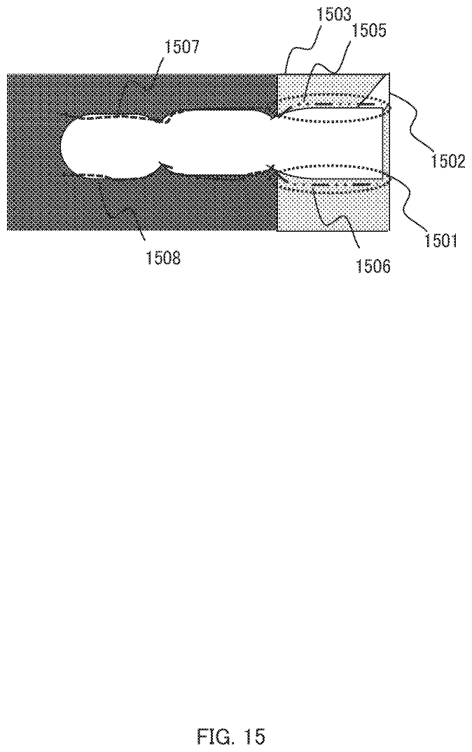

FIG. 15 is a diagram illustrating an example of estimating the contour of the finger on the base side by finger contour correction processing. The information processing device 10 inputs the contour lines 1507 and 1508 of the finger on the fingertip side as input data into the trained model, and estimates the contour lines 1505 and 1506 of the finger on the base side, thereby correctly recognizing the contour lines of the finger on the base side regardless of the background structure 1502.

### Embodiment 2

Embodiment 1 detects the height of the finger 116 by providing the reflection plate 106 on the rear wall 107 in the insertion chamber 119. In contrast, Embodiment 2 detects the height of the finger 116 by providing a similar reflection plate on the side wall 113 (inner side surface of the insertion chamber 119).

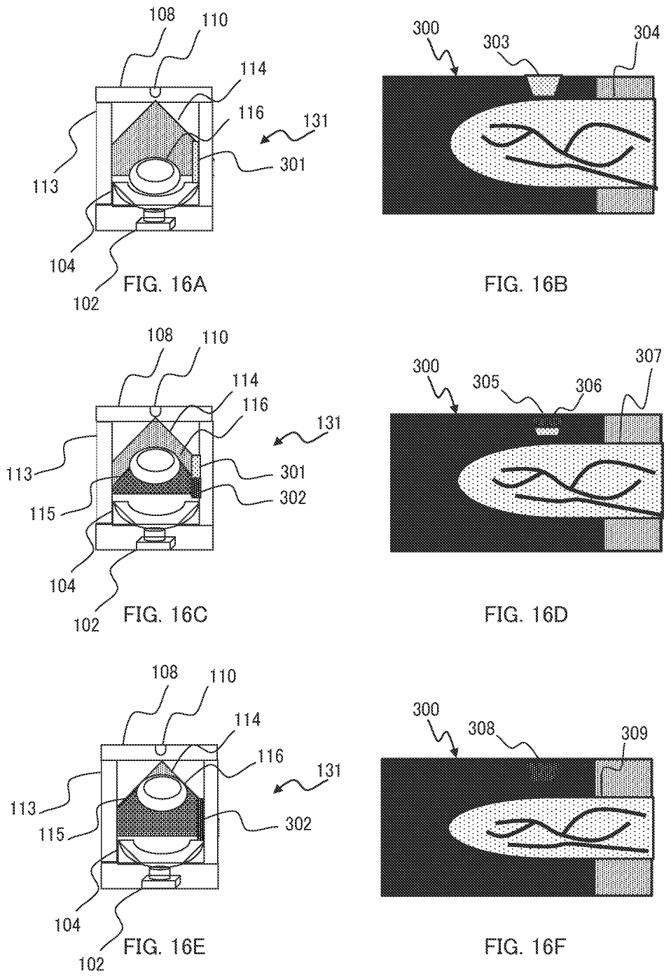

FIGS. 16A to 16F are diagrams illustrating an example of a contactless biometric authentication device 131 according to Embodiment 2 as viewed from the side of the opening 117 of the insertion chamber 119 and an example of a captured image captured by the contactless biometric authentication device 131. The contactless biometric authentication device 131 of the present embodiment detects the height of the finger 116 by including the reflection plate 301 from the bottom of the side wall 113 to the vicinity of the central height. The rest of the contactless biometric authentication device 131 is the same as that of the contactless biometric authentication device 101 of Embodiment 1.

The height and direction of the side wall 113 (inner side surface) of the reflection surface of the reflection plate 301 are adjusted, based on the same principles as those of Embodiment 1, such that if the light from the second light source 110 is blocked by the tip of the finger 116 inserted into the insertion chamber 119, then the light from the second light source 110, in a proportion corresponding to the height of the finger inserted, reaches and reflects off the reflection plate 301. Details are as follows.

First, FIG. 16A shows a case (fourth case) in which the finger 116 is inserted into a low position of the insertion chamber 119 of a contactless biometric authentication device 131, and the finger 116 is rested on the fingertip-side finger rest 104 at its fingertip as in the conventional device. As shown in the figure, since the finger 116 is at a low position in the insertion chamber 119, the direct near-infrared light 114 from the second light source 110 is emitted on the entire reflection surface of the reflection plate 301 without being blocked by the finger 116.

FIG. 16B is a diagram illustrating an example of an image captured by the shooting device 102 in the fourth case. As shown in the figure, this captured image 300 shows a finger region 304. Here, as described above, the direct near-infrared light 114 from the second light source 110 is emitted onto the entire reflection surface of the reflection plate 301. Therefore, in the captured image 300, a bright region 303 corresponding to the reflection surface of the reflection plate 301, which is brightly lit throughout, appears.

Next, FIG. 16C shows a case (fifth case) in which the finger 116 is inserted into the insertion chamber 119 of the contactless biometric authentication device 131 at an intermediate height. As shown in the figure, the finger 116 is at the middle height of the insertion chamber 119. Therefore, part of the near-infrared light 114, which is the direct near-infrared light 114 from the second light source 110, reaches the dorsal side of the finger 116 and is blocked, and the finger shadow 115, which is a space below the ventral side of the finger, is formed below the finger 116. As a result, the dark portion 302 due to the finger shadow 115 is also formed on a part of the lower side of the reflection surface of the reflection plate 301. On the other hand, the remaining surface of the reflection surface of the reflection plate 301 is directly irradiated with the near-infrared light 114, and the near-infrared light received by that surface is reflected.

FIG. 16D is a diagram illustrating an example of an image captured by the shooting device 102 in the fifth case. A finger region 307 is shown in this captured image 300. The shape of this finger region 307 is similar to the finger region 304 shown in FIG. 16B, but the size thereof becomes smaller depending on the height of the finger 116 from the shooting device 102, since the height of the finger 116 is higher than the shooting device 102. Additionally, the authenticator's finger 116 blocks the irradiation of the near-infrared light from the second light source 110 at about the middle height of the insertion chamber 119 as described above. Therefore, a dark portion 302 is formed by the finger shadow 115 on a part of the surface on the lower side of the reflection surface of the reflection plate 301, while the remaining upper surface is directly irradiated with the near-infrared light reflected by the reflection plate 301. Therefore, the captured image 200 includes a dark region 305 corresponding to the dark portion 302 of the reflection plate 301 and a bright region 306 directly irradiated with the near-infrared light reflected by the reflection plate 301.

Next, FIG. 16E shows a case (sixth case) in which the finger 116 is inserted into the insertion chamber 119 of the contactless biometric authentication device 131 at a high position (a position close to the ceiling 108). In this case, as shown in the figure, the finger 116 is located at a high position in the insertion chamber 119 (near second light source 110). Therefore, most of the direct near-infrared light 114 from the second light source 110 reaches the dorsal side of the finger 116 and is blocked, and the finger shadow 115 is formed. As a result, a dark portion 302 due to the finger shadow 115 is formed on the entire reflection surface of the reflection plate 301.

FIG. 16F is a diagram illustrating an example of an image captured by the shooting device 102 in the sixth case. A finger region 309 is shown in this captured image 300. The shape of this finger region 309 is similar to the finger region 307 shown in FIG. 16D, but the size thereof becomes smaller depending on the height of the finger 116 from the shooting device 102, since the height of the finger 116 is higher than the shooting device 102. In addition, the authenticator's finger 116 blocks the irradiation of the near-infrared light from the second light source 110 at a high position of the insertion chamber 119 as described above. Therefore, a dark portion 302 by the finger shadow 115 is formed on the entire reflection surface of the reflection plate 301. Therefore, the captured image 200 only includes a dark region 308 corresponding to the dark portion 302 of the reflection plate 301.

As described above, in the captured image captured by the shooting device 102 when the finger 116 is inserted, the area of the surface of the dark portion 302 (or the area of the bright region) on the reflection plate 301 has a certain correlation (for example, a proportional relation) with the insertion height of the finger 116 at that time.

Therefore, as in Embodiment 1, when an authenticator inserts their finger 116, the information processing device 10 can calculate the size of the dark portion 302 captured by the shooting device 102 in the captured image, and from the calculated size can calculate the height of the authenticator's finger 116.

Note that the height of the reflection surface of the reflection plate 301 is preferably set such that when the finger 116 is inserted at approximately an intermediate height in the insertion chamber 119, the dark portion 302, formed by the near-infrared light 114 from the second light source 110 being blocked by the finger 116, and other brighter portions are formed.

Moreover, if the distance between the inserted finger 116 and the side wall 113 differs, the size of the dark portion 302 also differs, so that an error may occur in detecting the height of the finger 116. Thus, the reflection plate 301 may be installed on each of the left and right side walls 113, and the average value of the height of the authenticator's finger 116 obtained from each of these side walls 113 may be employed. Thereby, the calculation error of the height of the finger 116 can be reduced.

### Embodiment 3

In Embodiment 1, the information processing device 10 detects the height of the dorsal side of the finger. In contrast, in Embodiment 3, the information processing device detects the height of the ventral side of the finger by providing a new light source on the side wall. This is because the thickness of the finger differs from person to person, so when the height of the dorsal side of the finger is obtained, the height of the veins on the ventral side of the finger will include an error due to variations in the thickness of the finger of each person. Therefore, the contactless biometric authentication device 101 according to Embodiment 3 obtains the height of the ventral side of the finger and calculates the accurate distance from the shooting device to the veins of the finger, making it possible to perform vein authentication with high accuracy.

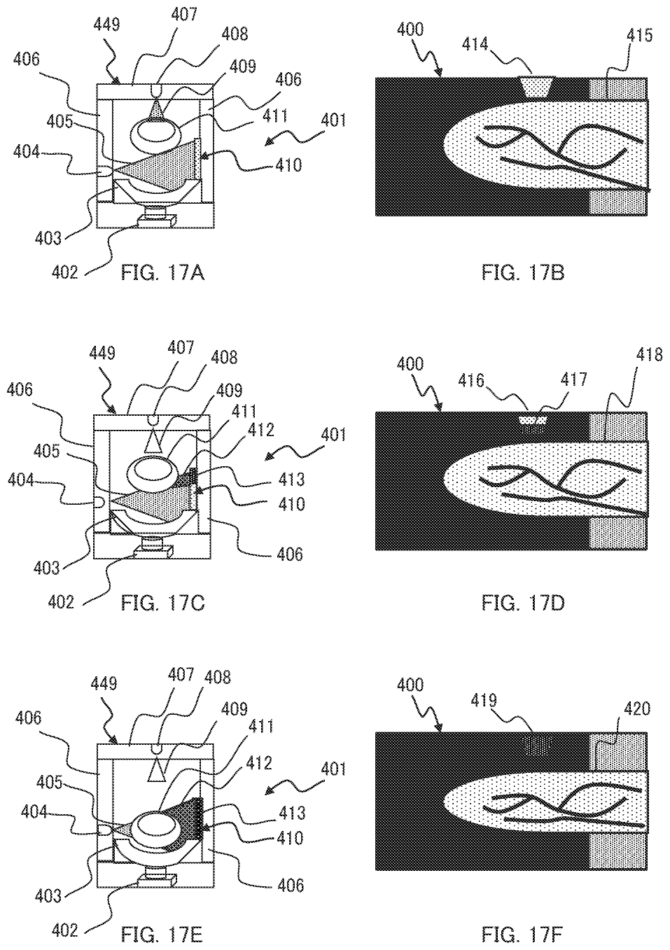

FIGS. 17A to 17F are diagrams illustrating an example of a contactless biometric authentication device 401 according to Embodiment 3 as viewed from the side of the opening of the insertion chamber 449 and an example of a captured image captured by the contactless biometric authentication device 401. The contactless biometric authentication device 401 of the present embodiment, as in Embodiment 1, includes a fingertip finger rest 403, left and right side walls 406, a ceiling 407, a first light source 408 that emits near-infrared rays 409 for capturing an image of a finger 411 from obliquely above, a second light source (not illustrated), and a shooting device 402.

Furthermore, one of the side walls 406 is provided with a third light source 404 that is fixed to the lower portion of the inner surface thereof and emits near-infrared light laterally into the insertion chamber 449. In addition, the other of the side walls 406 is provided with a reflection plate 410 that includes a reflection surface for receiving and reflecting near-infrared light 405 from the third light source 404. The rest of the contactless biometric authentication device 401 according to Embodiment 3 is the same as that of Embodiment 1.

The height of the third light source 404 is set so low that the direct near-infrared light 405 from the third light source 404 does not strike the ventral side of the finger 441 when the finger 441 is inserted into the upper portion of the insertion chamber 449.

More specifically, (the range of) the height of the third light source 404 and the height of the reflection surface of the reflection plate 410 are adjusted such that when the direct light from the third light source 404 is blocked by the fingertip of the finger inserted at or below a predetermined height in the insertion chamber 449, the light from the third light source 404, in a proportion corresponding to the height of the inserted finger, does not reach the reflection surface of the reflection plate 410.

First, FIG. 17A shows a case (seventh case) in which the finger 441 is inserted into the insertion chamber 449 of the contactless biometric authentication device 401 at a high position (a position close to the ceiling 407). The near-infrared light 405 from the third light source 404 strikes the entire reflection surface of the reflection plate 410 without being blocked by the finger 411 because the finger 411 is at a high position.

FIG. 17B is a diagram illustrating an example of an image captured by the shooting device 402 in the seventh case. This captured image 400 shows a finger region 415. In addition, since the authenticator's finger 411 does not block the near-infrared light from the third light source 404 as described above, in the captured image 400, a bright region 414 corresponding to the reflection surface of the reflection plate 410, which is brightly lit throughout, appears.

Next, FIG. 17C shows a case (eighth case) in which the finger 411 is inserted into the insertion chamber 449 of the contactless biometric authentication device 401 at an intermediate height (when the ventral side of the finger 411 reaches a predetermined height or less). Regarding the near-infrared light 405 from the third light source 404, the finger 411 is at the middle height of the insertion chamber 449. Therefore, part of the near-infrared light 405 is blocked on the ventral side of the finger 411 according to the height of the finger 411, and a space for the finger shadow 412 is formed on the reflection plate 410 side of the finger 411. As a result, the dark portion 413 due to the finger shadow 412 is formed on a portion of the upper part of the reflection surface of the reflection plate 410. On the other hand, the remaining surface of the reflection surface of the reflection plate 410 is directly irradiated with the light from the reflection plate 410, and the surface receives the light and reflects the light.

FIG. 17D is a diagram illustrating an example of an image captured by the shooting device 402 in the eighth case. A finger region 418 is shown in this captured image 400. In addition, the authenticator's finger 441 blocks the irradiation of the near-infrared light from the third light source 404 at about the middle height of the insertion chamber 449 as described above. Therefore, a dark portion 413 is formed by the finger shadow 412 on a part of the surface on the lower side of the reflection surface of the reflection plate 410, while the remaining upper surface is directly irradiated with the near-infrared light reflected by the reflection plate 410. Therefore, the captured image 400 includes a dark region 417 corresponding to the dark portion 413 of the reflection plate 410 and a bright region 416 directly irradiated with the near-infrared light reflected by the reflection plate 410.

Next, FIG. 17E shows a case (ninth case) in which the finger 411 is inserted into the insertion chamber 449 of the contactless biometric authentication device 401 at a low position. As to the near-infrared light 405 from the third light source 404, since the finger 441 is at a low position in the insertion chamber 449, all the near-infrared light 405 from the third light source 404 is blocked by the finger 441 to form a space for the finger shadow 412, and the near-infrared light 405 does not reach the reflection plate 410. As a result, a dark portion 413 due to the finger shadow 412 is formed on the entire reflection surface of the reflection plate 410.

FIG. 17F is a diagram illustrating an example of an image captured by the shooting device 402 in the third case. A finger region 420 is shown in this captured image 400. In addition, the authenticator's finger 116 blocks the irradiation of the near-infrared light from the third light source 404 as described above, so that a dark portion 413 by the finger shadow 412 is formed on the entire reflection surface of the reflection plate 410. Therefore, the captured image 200 only includes a dark region 419 corresponding to the dark portion 413 of the reflection plate 410.

As described above, in the captured image captured by the shooting device 402 when the finger 411 is inserted, the area of the surface of the dark portion 413 (or the area of the bright region) on the reflection plate 410 has a certain correlation (for example, a proportional relation) with the insertion height of the finger 411 at that time. In particular, the dark portion 413 on the reflection plate 410 appears when the lower surface, that is, the height of the ventral side, of the finger 411 becomes equal to or less than a predetermined height.

Therefore, as in Embodiment 1, when an authenticator inserts their finger 411, the information processing device can calculate the size of the dark portion 413 captured by the shooting device 402 in the captured image, and more accurately calculate the height on the ventral side, that is, the height of the veins, of the authenticator's finger 411 from the calculated size.

Note that if the distance between the authenticator's finger 411 and the side wall 406 differs, the size of the dark portion 413 also differs, so that an error may occur in detecting the height of the finger 411. Thus, the reflection plate 410 may be installed on each of the left and right side walls 406, and the average value of the height of the ventral side of the authenticator's finger 411 obtained from each of these side walls 406 may be employed, which makes it possible to further reduce calculation errors in the height of the ventral side of the finger 411.

### Embodiment 4

In the present embodiment, the contactless biometric authentication device 101 includes a fourth light source for guiding the insertion of the finger 116.

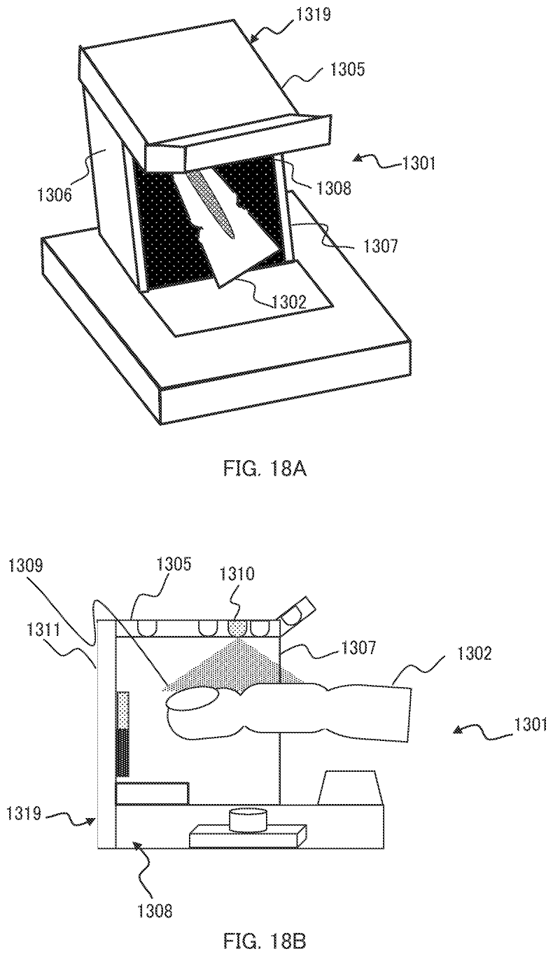

FIGS. 18A and 18B are diagrams illustrating the configuration of a fourth light source 1310 according to Embodiment 4. Specifically, FIG. 18A is a diagram of the contactless biometric authentication device 1301 as viewed from above on the opening 117 side. FIG. 18B is a cross-sectional view of the contactless biometric authentication device 1301 where the finger 1302 has been inserted, as viewed from the side.

As shown in FIGS. 18A and 18B, the insertion chamber 1308 of the contactless biometric authentication device 1301 includes a ceiling 1305 and two side walls 1306 and 1307, as in Embodiment 1.

A fourth light source 1310 is attached to the central portion of the inner surface of the ceiling 1305 to indicate the inserting direction of the finger 1302 to the authenticator.

Specifically, the irradiation range of the fourth light source 1310 is the central portion of the insertion direction of the insertion chamber 1319 from the opening of the insertion chamber 1319 toward the far side of the insertion chamber 1319 (the rear wall 1311 side). That is, the irradiation direction of the irradiation light 1309 of the fourth light source 1310 is adjusted along the insertion direction of the finger 1302 so as to strike the central portion of the dorsal side of the finger 1302.

Note that the irradiation light 1309 is visible light, for example, red or blue visible light that is easily recognized by the authenticator.

As a result, when the authenticator inserts the finger 1302 with the back facing up along the irradiation light 1309 from the fourth light source 1310, the finger 1302 is naturally inserted into an appropriate position in the insertion chamber 1319 (the position where a correct authentication image can be obtained).

As described above, the contactless biometric authentication device 1301 of the present embodiment can prompt the authenticator to insert the finger in a position suitable for authentication by emitting a visible ray indicating the position and direction in which the finger 1302 should be inserted.

### Embodiment 5

The side wall 113 in the contactless biometric authentication device 101 of Embodiment 1 is provided perpendicular to the installation surface 12, but the installation direction of the side wall 113 may be changed as follows.

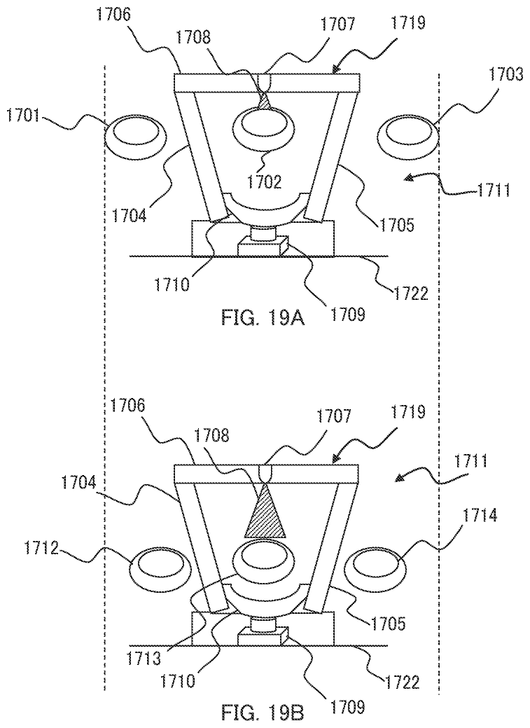

FIGS. 19A and 19B are cross-sectional views of the contactless biometric authentication device 1711 according to Embodiment 5 as viewed from the fingertip direction when the finger is inserted. Specifically, FIG. 19A is a cross-sectional view when the central one finger 1702 out of the three fingers 1701, 1702, and 1703 is inserted into the insertion chamber 1719 from above, and FIG. 19B is a cross-sectional view when the central one finger 1713 out of the three fingers 1712, 1713, and 1714 is inserted into the insertion chamber 1719 from below.

As shown in the figures, this contactless biometric authentication device 1711 includes a shooting device 1709, a fingertip-side finger rest 1710, side walls 1704 and 1705, a ceiling 1706, a second light source 1707 that emits near-infrared rays 1708, and the like, as in Embodiment 1.

Here, the side walls 1704 and 1705 are provided opposite to each other, but their standing directions are different from those of Embodiment 1.

That is, the space in the insertion direction of the finger 1702 in the insertion chamber 1719 is formed such that the upper space is wider than the lower space. In the example shown in the figures, the side walls 1704 and 1705 extend in a wedge shape rather than in a vertical direction with respect to the installation surface 1722. In other words, the side walls 1704 and 1705 are slanted outward so that the space formed by the side walls 1704 and 1705 and the rear wall becomes wider toward the top of the insertion chamber 1719.

The width of the opening at the top of the insertion chamber 119 is set to a width with which the fingers 1701 and 1703 adjacent to the finger 1702 to be inserted toward the opening abut.

For example, the spacing at the lower portion between the side walls 1704 and 1705 is slightly wider than the width of the inserting finger. Also, the spacing at the top between the side walls 1704 and 1705 is adjusted so that a finger adjacent to inserting finger 1702 can easily abut the side walls 1704 and 1705.

This prompts the authenticator to insert the finger 1702 at a lower position because if the finger 1702 is to be inserted at a high position, the fingers 1701 and 1703 adjacent to the finger 1702 will hit the side walls 1704 and 1705 of the insertion chamber 1719 unless the fingers 1701 and 1703 are intentionally spread.

As shown in FIG. 19A, in order to insert one finger 1702 out of the three fingers 1701, 1702, and 1703 presented by the authenticator into the insertion chamber 1719 without contacting the upper portions of the side walls 1704 and 1705, the three fingers 1701, 1702, and 1703 need to be consciously spread. On the other hand, as shown in FIG. 19B, when inserting one finger 1702 out of the three fingers 1701, 1702, and 1703 presented by the authenticator into the insertion chamber 1719 so as not to contact the lower parts of the side walls 1704 and 1705, the need to spread the three fingers 1701, 1702, and 1703 far apart is small.

As a result, the authenticator can be guided not to insert the finger into the insertion chamber 1719 at a high position. Thus, the contactless biometric authentication device 1711 can acquire an authentication image in which a larger finger is captured, and can perform highly accurate authentication.

Note that the degree of inclination of the side walls 1704 and 1705 can be appropriately changed depending on how high the finger of the authenticator is to be guided in the insertion chamber 119. Also, the side walls 1704 and 1705 may be curved along the shape of the finger to be inserted.

As described above, the contactless biometric authentication device of the present embodiment includes an insertion chamber, a shooting device which captures the ventral side of a finger inserted into the insertion chamber, a first light source for finger detection on the far side of the insertion chamber from the shooting device, a second light source which emits near-infrared light, and a reflection surface (reflection plate) which reflects light from the second light source, wherein the position and direction of the reflection surface are adjusted so that when the first light source detects the insertion of a finger, it receives the light from the second light source in a proportion corresponding to the height of the inserted finger, and the shooting device captures an image including the light reflected by the reflection plate and the finger.

That is, in the contactless biometric authentication device of the present embodiment, the amount of light from the second light source that is reflected from the reflection plate and reaches the shooting device varies depending on the height of the inserted finger. As a result, information on the height of the inserted finger is included in the image captured by the shooting device.

In a contactless-type authentication device like the present embodiment, the position of the body as the authentication target (the height of the finger in the present embodiment) is often different for each authentication operation of the authenticator, which causes a reduction in accuracy of authentication. Therefore, according to the contactless biometric authentication device of the present embodiment, accuracy of authentication can be improved by performing predetermined image correction (such as correction of image distortion) based on finger height information included in the captured image.

As described above, according to the contactless biometric authentication device of the present embodiment, contactless authentication can be performed with high accuracy. In this case, there is no need to introduce additional sensors or the like.

Further, the contactless biometric authentication device of the present embodiment includes a plurality of second light sources and a near-infrared ray light source control device which adjusts the light intensity of each of the second light sources, wherein each second light source is arranged in alignment in a direction in which the light from the second light sources is emitted onto the central portion of the dorsal side of the finger in the insertion direction.

This makes it easier to adjust the average luminance of the finger 116 in the authentication image to a predetermined target luminance, so that an authentication image with stable quality suitable for authentication can be captured.

In addition, in the contactless biometric authentication device of the present embodiment, the first light source emits directional light and is provided at a position on the far side of the insertion chamber than the second light source, where direct light from the first light source does not reflect more than a predetermined amount on the rear wall of the insertion chamber.

This makes it possible to prevent the direct light from the first light source from appearing in the image of the shooting device 102 or interfering with the light from the second light sources to cause issues with detection of finger insertion performed by the first light source.

In addition, the contactless biometric authentication device of the present embodiment includes, on the side wall, a reflection surface that reflects light from the second light source, wherein the height of the reflection surface on the side wall surface is adjusted to a height at which it receives the light from the second light source in a proportion corresponding to the height of the inserted finger when the finger inserted into the insertion chamber blocks the light from the second light source.

As a result, the amount of light from the second light sources that is reflected from the reflection surface and reaches the shooting device varies depending on the height of the inserted finger. Thus, the image captured by the shooting device includes information on the height of the inserted finger. Using this image, contactless authentication can be performed with high accuracy.

In addition, the contactless biometric authentication device of the present embodiment includes a third light source at the lower portion of the inner surface of one inner wall, and a reflection surface on the lower portion of the other inner wall which reflects light from the third light source, wherein the height of the third light source and the reflection surface on the inner surface is adjusted so that when the light from the third light source is blocked by the finger inserted into the insertion chamber at a predetermined height or lower, the light from the third light source in a proportion corresponding to the height of the inserted finger does not reach the reflection surface.

As a result, the amount of light from the third light source that is reflected by the reflection surface and reaches the shooting device varies depending on the height of the finger inserted at a lower level. Thus, the image captured by the shooting device includes information on the height of the inserted finger, particularly information on the height on the lower side of the finger (height on the ventral side). Using this image, contactless authentication can be performed with high accuracy.

In addition, the information processing device 10 of the contactless biometric authentication system 1 of the present embodiment instructs the second light sources to emit light upon determining that the light from the first light source is blocked by the fingertip of the finger inserted into the insertion chamber, identifies the vein pattern of the inserted finger based on the region of the light of the second light source included in the image captured by the shooting device, and compares the identified vein pattern of the finger with the template image to perform authentication of the finger as the authentication target.

In this manner, the insertion of the fingertip into the insertion chamber is detected with the first light source, and an authentication image is obtained with the second light sources that start irradiation accordingly. As a result, the authentication of the finger as the authentication target can be reliably performed.

In addition, the information processing device 10 of the contactless biometric authentication system 1 of the present embodiment calculates the luminance around the portion of light from the first light source in the authentication image and, only when the calculated luminance is determined to be equal to or greater than a predetermined threshold, determines that the light from the first light source has been blocked by the fingertip of the finger inserted into the insertion chamber, and instructs the second light source to emit light.

Since the fingertip of the finger is thin, the first light source may transmit a large amount of light through the fingertip of the finger, causing luminance saturation. In this case, it may be impossible to determine whether the image captured by the shooting device has become brighter due to the luminance saturation at the fingertip of the inserted finger, or whether it has become brighter due to the light from the first light source with the finger yet to be inserted. Therefore, by determining that the fingertip of the finger has been inserted when the luminance around the portion of the light from the first light source is high, insertion of the finger can be accurately determined.

In addition, the information processing device 10 of the contactless biometric authentication system 1 of the present embodiment identifies the relationship between the width of a cylindrical object in an image captured by the shooting device and the width of the cylindrical object in the image captured by a conventional device with a different focal length from the shooting device, and corrects the size of the captured image based on the identified relationship.

There is a high possibility that the image captured by the shooting device in the contactless-type authentication device will differ in how the living body appears in each image due to the particular characteristics of contactless authentication, so that a shooting device with a longer focal length than the conventional device is used (for example, a lens with a deep depth of field that reduces the difference in how the subject is captured is used). Therefore, a problem arises in compatibility between the contactless biometric authentication device of the present embodiment and the conventional device. However, according to the above configuration, it is possible to use the template image obtained by the conventional device having a different focal length, and to ensure compatibility with the conventional device.

In addition, the information processing device 10 of the contactless biometric authentication system 1 of the present embodiment calculates the position of the tip portion of the finger and the width of the finger from the authentication image, and based on the calculated tip portion of the finger and finger width, extracts the region necessary for finger authentication from the authentication image (for example, an image of the same size as the authentication image obtained by a conventional device), and identifies the vein pattern of the finger based on the image of the extracted region.

A contactless-type authentication device tends to capture different images of a finger for each operation, so that images of a wider range of fingers are captured than in the case of a conventional device. In this case, it is necessary to extract a partial region of the image in order to ensure compatibility with the image obtained by the conventional device. Here, according to the above configuration, an image of the conventional device, for example, an image compatible with a template image obtained by the conventional device can be used to ensure compatibility with the conventional device. In particular, since there is a certain relationship between human finger width and finger length, the above configuration can be used to extract an appropriate image region.

In addition, the contactless biometric authentication device of the present embodiment includes a visible-light light source which is provided above the height at which the finger is inserted, and whose irradiation range is the central portion of the insertion chamber extending from the opening of the insertion chamber toward the far side of the insertion chamber.

As a result, the authenticator is prompted to insert the finger into the insertion chamber in a certain direction, and the shooting device can capture an authentication image with high authentication accuracy.

Further, an extension extending toward the line of sight of the authenticator is formed at the end of the opening in the ceiling of the insertion chamber of the contactless biometric authentication device of the present embodiment.

The interior of the insertion chamber into which the finger is inserted is difficult for the authenticator to see, and the authenticator is psychologically reluctant to have the finger inserted. Therefore, by providing an extension on the opening side of the ceiling as described above, and making it easy to see the interior space of the insertion chamber and the finger inserted therein from the authenticator, the authenticator can easily use the contactless biometric authentication device.

Further, in this case, the information processing device of the contactless biometric authentication system 1 of the present embodiment estimates the contour of the finger on the base side by inputting the information on the finger contour on the fingertip side included in the image captured by the shooting device into a numerical model that estimates the shape of the contour of the finger on the base side from the shape of the contour of the finger on the fingertip side.

When the extension is provided as described above, the base portion of the finger in the authentication image may increase in luminance due to the entry of external light, resulting in an image with an unclear contour. Therefore, using a numerical model for estimating the contour of the base of the finger from the contour of the fingertip of the finger, the contour of the base of the finger can be estimated from the captured image, making it possible to obtain an authentication image suitable for authentication.

In addition, the space in an insertion direction of the finger in the insertion chamber of the contactless biometric authentication device of the present embodiment is formed such that the upper space thereof is wider than the lower space, and the width of the opening at the upper part of the insertion chamber is set to a width that a finger adjacent to the finger entering the opening abuts.

In the contactless biometric authentication device of the present embodiment, the distance between the finger and the shooting device is shorter when the finger is inserted at a lower position, so that the shooting device can easily capture a clearer image, and the authentication accuracy can be improved. Therefore, by configuring as described above, the authenticator will find it less burdensome to insert their finger at a lower position in the insertion chamber rather than at a higher position. In other words, when the authenticator attempts to insert the finger at a higher position in the insertion chamber, the adjacent finger touches the side wall, so that they tries to lower the finger insertion position. This makes it possible to obtain an authentication image that is more suitable for authentication.

The present disclosure is not limited to the above-described embodiments, and can be implemented using any components without departing from the gist of the present disclosure. The embodiments and modifications described above are merely examples, and the present disclosure is not limited to these contents as long as the features of the present disclosure are not impaired. Moreover, although various embodiments and modifications have been described above, the present disclosure is not limited to these contents. Other aspects conceivable within the scope of the technical idea of the present disclosure are also included in the scope of the present disclosure.

For example, the configurations of each embodiment described in the present specification may be combined.

Also, part of the hardware included in the device of each of the present embodiments may be provided in another device. Further, some of the functional units included in each device of the present embodiments may be provided in another device, or functional units included in another device may be provided in the same device.

What is claimed is:

1. A contactless biometric authentication device comprising:
an insertion chamber which includes an opening in one side and a space into which an authenticator's finger is inserted from the opening toward a far side of the insertion chamber;
a shooting device which is installed at a position to capture the ventral side of the finger inserted into the insertion chamber;
a first light source which is installed at a position on the far side of the shooting device in the insertion chamber and emits light toward the shooting device, the light being blocked by the inserted finger;
a second light source which is provided at a higher position than a height at which the finger is inserted, emits light within a predetermined range including the shooting device when the light from the first light source is blocked by the finger, the light being absorbed by a blood vessel of the finger; and
a reflection surface which is provided in the insertion chamber and receives and reflects the light from the second light source,
wherein a position and direction of the reflection surface are adjusted to reflect the light from the second light source in a proportion corresponding to the height of the inserted finger when the light from the first light source is blocked by the finger, and
the shooting device captures an image including the light reflected from the reflection surface and the ventral side of the inserted finger.

2. The contactless biometric authentication device according to claim 1, further comprising:
a plurality of second light sources; and
a control device which adjusts a light intensity of each of the second light sources,
wherein the second light sources are aligned in a direction in which the light from the second light sources is emitted onto a central portion of the dorsal side of the inserted finger in an insertion direction.

3. The contactless biometric authentication device according to claim 1, wherein the first light source emits directional light and is provided at a position on the far side of the insertion chamber than the second light source, where direct light from the first light source does not reflect more than a predetermined amount on an inner surface on the far side of the insertion chamber.

4. The contactless biometric authentication device according to claim 1, further comprising, on an inner side surface in the insertion chamber, a reflection surface including a surface which receives and reflects the light from the second light source,
wherein a height of the reflection surface on the inner side surface is adjusted to a height at which the surface receives the light from the second light source in a proportion corresponding to the height of the inserted finger when the finger inserted into the insertion chamber blocks the light from the second light source.

5. The contactless biometric authentication device according to claim 1, further comprising:
a third light source at a lower portion of one of opposing inner side surfaces in the insertion chamber; and
a reflection surface on a lower portion of the other of the inner side surfaces which receives and reflects light from the third light source,
wherein a height of the third light source and the reflection surface on the inner side surface is adjusted so that when the light from the third light source is blocked by the finger inserted into the insertion chamber at a predetermined height or lower, the light from the third light source in a proportion corresponding to the height of the inserted finger does not reach the reflection surface.

6. A contactless biometric authentication system comprising:
an insertion chamber which includes an opening in one side and a space into which an authenticator's finger is inserted from the opening toward a far side of the insertion chamber;
a shooting device which is installed at a position to capture the ventral side of the finger inserted into the insertion chamber;
a first light source which is installed at a position on the far side of the shooting device in the insertion chamber and emits light toward the shooting device, the light being blocked by the inserted finger;
a second light source which is provided at a higher position than a height at which the finger is inserted and emits light within a predetermined range including the shooting device when the light from the first light source is blocked by the finger, the light being absorbed by a blood vessel of the finger; and
a reflection surface which is provided in the insertion chamber and receives and reflects the light from the second light source,
wherein a position and direction of the reflection surface are adjusted to reflect the light from the second light source in a proportion corresponding to the height of the inserted finger when the light from the first light source is blocked by the finger, and
the shooting device includes a contactless biometric authentication device which captures an image including the light reflected from the reflection surface and the ventral side of the inserted finger, and an information processing device which is communicably coupled to the contactless biometric authentication device,
wherein the information processing device
instructs the second light sources to emit light upon determining that the light from the first light source is blocked by a fingertip of the finger inserted into the insertion chamber,
identifies a vein pattern of the inserted finger based on a region of the light of the second light source included in the image captured by the shooting device, and
compares the identified vein pattern of the finger with a pre-registered vein pattern to perform authentication of the finger of the authenticator.

7. The contactless biometric authentication system according to claim 6, wherein, when detecting a portion of the light from the first light source based on the image captured by the shooting device, the information processing device, calculates luminance around the portion, determines whether the calculated luminance is equal to or greater than a predetermined threshold, and only when the calculated luminance is determined to be equal to or greater than a predetermined threshold, determines that the light from the first light source has been blocked by the fingertip of the finger inserted into the insertion chamber and instructs the second light source to emit light.

8. The contactless biometric authentication system according to claim 6, wherein the information processing device:
identifies a relationship between a size of a predetermined subject in the image captured by the shooting device and a size of the subject in an image captured by a different shooting device with a different focal length from the shooting device; and
instructs the second light source to emit light and then corrects the size of the image captured by the shooting device based on the identified relationship.

9. The contactless biometric authentication system according to claim 6, wherein the information processing device:
instructs the second light source to emit light and then uses the image captured by the shooting device to calculate a position of the tip portion of the finger in the image and a width of the finger in the image; and
based on the calculated tip portion of the finger and finger width, extracts a region necessary for finger authentication from the captured image and identifies the vein pattern of the finger based on the image of the extracted region.

10. The contactless biometric authentication device according to claim 1, further comprising a visible-light light source which is provided above the height at which the finger is inserted, and whose irradiation range is a central portion of the insertion chamber extending from the opening of the insertion chamber toward the far side of the insertion chamber.

11. The contactless biometric authentication device according to claim 1, wherein an extension extending toward a line of sight of the authenticator is formed at an end of the opening in the ceiling of the insertion chamber.

12. The contactless biometric authentication system according to claim 6, wherein an extension extending toward a line of sight of the authenticator is formed at an end of the opening in the ceiling of the insertion chamber, and
the information processing device:
stores a numerical model which estimates a shape of a contour of the finger on the base side from the shape of the contour of the finger on the fingertip side, and
instructs the second light source to emit light and then estimates the contour on the base side of the finger in the captured image based on the contour of the finger on the fingertip side included in the image captured by the shooting device and the numerical model to identify the vein pattern of the finger.

13. The contactless biometric authentication device according to claim 1, wherein a space in an insertion direction of the finger in the insertion chamber is formed such that an upper space thereof is wider than a lower space, and a width of the opening at an upper part of the insertion chamber is set to a width that a finger adjacent to the finger entering the opening abuts.

14. A contactless biometric authentication method comprising:
providing an insertion chamber which includes an opening in one side and a space into which an authenticator's finger is inserted from the opening toward a far side of the insertion chamber;
installing a shooting device at a position to capture the ventral side of the finger inserted into the insertion chamber;
installing a first light source at a position on the far side of the shooting device in the insertion chamber, which emits light toward the shooting device, the light being blocked by the inserted finger;
installing a second light source at a higher position than a height at which the finger is inserted, which emits light within a predetermined range, including the shooting device, when the light from the first light source is blocked by the finger, the light being absorbed by a blood vessel of the finger;
installing a reflection surface in the insertion chamber, which receives and reflects the light from the second light source;
adjusting a position and direction of the reflection surface to reflect the light from the second light source in a proportion corresponding to the height of the inserted finger when the light from the first light source is blocked by the finger; and
with the shooting device, capturing an image including the light reflected from the reflection surface and the ventral side of the inserted finger.
